(19) United States
(12) Patent Application Publication
(10) Pub. No.: US 2021/0364130 A1
(43) Pub. Date: Nov. 25, 2021

(54) SYSTEM FOR DETERMINING THE STATUS OF A GAS CYLINDER

(71) Applicant: Smart Cylinders AS, Oslo (NO)

(72) Inventors: Simon Grevstad, Oslo (NO); Tormod Haugland, Oslo (NO)

(73) Assignee: Smart Cylinders AS, Oslo (NO)

(21) Appl. No.: 17/256,725

(22) PCT Filed: Jun. 28, 2019
(86) PCT No.: PCT/EP2019/067491

§ 371 Date: Dec. 29, 2020

(30) Foreign Application Priority Data
Jun. 29, 2018 (GB) 1810766.4

(51) Int. Cl. F17C 13/02

(52) U.S. Cl. CPC F17C 13/023; F17C 13/026; F17C 2221/035; F17C 2250/0421; F17C 2250/077; F17C 2250/032; F17C 2260/038; F17C 2250/034; F17C 2250/0439

(57) ABSTRACT

According to the invention there is provided a system for determining a status of a gas cylinder, the system comprising: a load sensor configured to detect a weight of the cylinder at predetermined time intervals; a temperature sensor configured to detect a temperature local to the cylinder at the predetermined time intervals; and a processing unit configured to: receive weight signals and temperature signals from the load sensor and temperature sensor respectively; and determine, based on the received weight and temperature signals, the status of the gas cylinder; and provide an indication of the status of the gas cylinder to a user. A system for managing deployed cylinders is also provided. Methods and computer readable mediums are also provided.

### BACKGROUND

In both commercial and private environments, liquid petroleum gas (also known as LPG) is used in catering and heating systems.

A typical gas market comprises distributors and consumers. The consumers are typically restaurants and pubs which consume gas to power cooking appliances and dispense beer or other liquids. Consumers can also be private individuals. For the consumers of gas cylinders, a constant issue is figuring out when the cylinders are due to become empty and therefore when they need to order new cylinders. Having cylinders run empty can be very costly for businesses if essential appliances rely on gas to operate.

Similarly for the LPG distributors, there is a challenge knowing when the cylinders need to be replaced. The gas distributors supply the consumers with gas which is done using either gas cylinders, or a piped gas network. Typically, the private or commercial property is supplied with cylinders that are prefilled with LPG however the cylinders can be refilled on site. Engineers associated with the gas distributors and suppliers install the LPG cylinders in the property so that the consumer can use the gas for cooking and/or heating purposes. The cylinders are often arranged in a double array arrangement, in which each array comprises several cylinders, each array being separated by an activation switch. One array is used first to supply the consumer with gas and once this array is empty, the activation switch is triggered to engage the other array so that this full array may continue to supply the consumer with gas. At the point the switch is activated, a consumer knows that half of his total gas supply has been used, but after that point he does not know how much gas remains in the second array of cylinders. The consumer therefore does not know when he will run out of gas, only when half of his gas has been used up. The switch may be triggered manually or automatically. In the automatic case, pressure is typically monitored to identify when the switch should be activated. At low temperatures, the cylinders may stop yielding gas before they are depleted, i.e.: earlier than 0%.

In order for the system to run smoothly, a large national network of delivery depots and larger tanker fleets are required so that the consumer does not run out of gas. The optimum time for cylinder replacement is just before the cylinder becomes empty. For the distribution of gas cylinders, sheer customer numbers and the unpredictability of delivery times present a considerable challenge. The distributors often have several full time employees dedicated to the logistics involved in supplying their customers with gas optimally and extra storage is required to mitigate the unpredictability of gas usage.

The LPG cylinders are typically very heavy and hold gas under high pressure. As the cylinders are under high pressure, if a cylinder discharges or ruptures there are likely to be serious consequences including potential injury to the consumer. In addition, if a cylinder is installed incorrectly, there is an increased risk of gas leaking from the cylinder which could be dangerous.

Furthermore, if a cylinder discharges or leaks and the consumer is not aware of the situation, the cylinder will lose capacity without the consumer knowing. As well as being dangerous due to the cylinder surrounding potentially becoming filled with gas, the consumer may run out of gas unexpectedly if they are not aware that the gas cylinder has been leaking, which may disrupt business.

Another downside to gas cylinders discharging or leaking is that it is hard to apportion costs if gas usage cannot be determined accurately. This can become costly for the consumer as they are paying for gas which they did not use and they are not getting maximum usage from the cylinders.

large numbers Typically end consumers will keep at least one spare LPG cylinder on site for every cylinder that they need (e.g. if they have four cylinders in use, they will keep four spare cylinders so that each cylinder has a corresponding replacement cylinder). The number of spare cylinders kept on site is a balance between security (more spare cylinders results in an increased risk that they may be stolen) and the risk that the consumer runs out of gas (which may happen if there are not enough spare cylinders). A downside of this current system is that the supplier must predict when the consumer is going to run out of gas so that they can supply the replacement cylinders in time. The logistics of ensuring all consumers are being supplied with replacement LPG cylinders before they run out becomes more difficult to manage as the number of consumers increases and if they are more spread out across the country.

Due to the inherent dangers associated with storing gas in high pressure cylinders it is important to ensure that the cylinders come from reputable suppliers and are filled with gas that meets a number of health and safety standards. It would therefore be useful to be able to determine whether or not the gas cylinders received by the consumers are certified and regulated rather than being supplied by fraudulent distributors.

Gas cylinders are a valuable commodity for the consumers making them targets for theft. It would be useful to be able to track and monitor the gas cylinders that have been delivered to each consumer to prevent them from becoming targets for thieves. Furthermore, if the cylinders do get stolen, it would be beneficial to be able to track the cylinder so that it can be found and returned to either the consumer or the gas distributor.

Several errors may also arise when changing cylinders if they are installed in the wrong location, for example if full cylinders are installed on the wrong side of the activation switch (i.e. a full cylinder has been installed on an empty side) or a connection is not made properly.

Further issues arise within the ecosystem of LPG distribution. For example, conventionally the payment models are based around the number of gas cylinders are that sold, not by volume of gas used, i.e. on a per cylinder basis. This means that consumers pay each time a cylinder is replaced irrespective of whether there remains usable fluid in the cylinder which may be reused by the distributer. As implied above, there are several logistics issues arising such as the effective coordination of deliveries and refilling and there is currently no effective system available to track cylinders around the ecosystem.

It would also be beneficial to accurate estimate and predict usage in all scenarios so that consumers and distributors can accurately identify and predict current and future usage.

One example of a prior art system is described in DE102015009392 which provides a device for measuring current stock of LPG in a single pressure vessel and transmitting the information to a central database. The weight of the pressure vessel is measured and the amount of gas in the vessel is determined using a microprocessor, based on the weight measurement. This value is then transmitted to the central database for storage. The system is unusable to accurately determine gas yield using the weight and requires a weight sensor for each cylinder. In commercial premises, multiple cylinders are typically deployed in parallel. Typically, each cylinder has one sensor positioned underneath the cylinder in order to collect data, such as weight data, from the cylinder. This results in a large number of sensors in current systems. A typical set up can be seen, for example, in prior art document EP1043540.

To reiterate, the current gas market has several problems associated with supplying and consuming gas from high pressure gas cylinders. Inaccurate determination of the amount of gas in each cylinder can lead to disruption in the flow of gas at the consumer end. In addition, abnormal usage and faults in the system are harder to detect if the amount of gas in the cylinders cannot be accurately estimated. Finally, current gas cylinders are at risk of being stolen or used by unauthorised persons as they are difficult to track.

Additional problems with the current gas market include large amounts of capital being tied up in spare cylinders that are stored on site which not only binds capital for both the consumer and distributors but also increases the risk of theft, inefficient collection and delivery of gas cylinders as the consumer and supplier do not know when a cylinder is going to run out, consumers being charged on a per cylinder basis which is typically expensive, and a large number of sensors are required in order to determine the amount of in cylinders as each cylinder typically requires one sensor to take measurements.

To avoid some of the current problems it would be useful to have a system which provides improved estimation of the amount of gas used and detects abnormal usage. It would also be useful to have a system which can track the gas cylinders so that abnormal events can be identified.

The present invention aims to overcome at least some of the abovementioned problems.

### SUMMARY OF INVENTION

According to an aspect of the invention there is provided a system for determining a status of a gas cylinder, the system comprising: a load sensor configured to detect a weight of the cylinder at predetermined time intervals; a temperature sensor configured to detect a temperature local to the cylinder at the predetermined time intervals; and a processing unit configured to: receive weight signals and temperature signals from the load sensor and temperature sensor respectively; determine, based on the received weight and temperature signals, the status of the gas cylinder; and provide an indication of the status of the gas cylinder to a user.

By “processing unit”, we are referring to a part of a computer system that is configured to carry out the instructions of a computer program by performing computer operations specified by the computer instructions. Thus, when we refer to a processing unit, it is implicit that there is an associated computer system to which the processing unit belongs. The processing unit may be local to the cylinders and communicate using a local area network or may be located remotely, communicating over the internet. The functionality of the processing unit may be divided amongst multiple computer systems for example a local processing unit and a cloud server or functionality may be performed entirely in the cloud.

Combining both weight signals and temperature signals provides an accurate estimation of the status of the cylinder. This is because the temperature of the cylinder affects the amount of usable gas in the cylinder due to pressure changes and so if the temperature is not taken into account, the weight of the cylinder may provide an inaccurate estimation of the usable gas in the cylinder. In some cases both the local temperature, which is a temperature of the surface of the cylinder of very close to the surface of the cylinder, and the regional or ambient temperature, which is a temperature of the general area in which the cylinder is located, are taken into account when estimating the status of the cylinder.

Automatically indicating the status of the cylinder to the user allows the user to stay informed about the general status of the cylinder without having to manually intervene and determine for himself the status of the cylinder. Thus the automatic system is intuitive and simple to use for users of any age and experience. In addition providing a more accurate estimation of the status of the cylinder allows abnormal usage and errors to be determined more easily. A more accurate system allows for the detection of less significant errors, which prevent large errors in the long run as the user is able to correct the problem early on. Overall, the system provides a more accurate estimation of the status of the cylinder which, in turn, leads to better identification of abnormal events and errors.

In some embodiments, the system includes a tripod foot. This can be used to support the gas cylinder and its local sensors. The tripod foots helps elevate the gas cylinder and its sensors from the floor, so that there is some clearance or air space between the base of the cylinder and the floor. This allows for easy access to the cylinders and sensors by a consumer for example by providing easy access to plugs and sockets which are required to connect the various sensors to the rest of the system, or to the pipelines needed to connect the cylinder to the rest of the installation.

In certain embodiments the system may also retrieve a tare weight and determine the status based on the tare weight and the weight and temperature signals. The tare weight may be calculated for each cylinder or may be estimated based on cylinder type or based on a default value. The tare weight represents the weight of an unladen cylinder. That is, the tare weight corresponds to the weight of a cylinder when there is no gas inside the cylinder. Thus, the tare weight is the weight of an empty cylinder.

The system may further comprise a transceiver configured to receive signals from the load sensor and the temperature sensor, the signals corresponding to weight data and temperature data respectively, and send the weight data and temperature data to the processing unit. In this way the processing unit may be located centrally to enable a lightweight sensor at the premises to be installed.

The processing unit may be configured to retrieve a tare weight, calculate a difference between the tare weight and the received weight data to determine a weight difference, the processing unit subsequently configured to: compare the weight difference with a threshold value; and, modify the comparison using the received temperature data.

Calculating a difference between the tare weight and the received weight data allows a more accurate estimation of the weight of the cylinder to be calculated as the weight of the empty cylinder is taken into account. Advantageously, this may account for manufacturing differences between different brands of gas cylinder which may otherwise affect the weight data, providing inaccurate estimations of the amount of gas in the cylinder. Furthermore, since the temperature of the cylinder affects the amount of usable gas in the cylinder, the weight alone does not provide an accurate indication of the amount of usable gas, and therefore the status, of the cylinder. Including temperature data advantageously takes into account the effect the atmosphere has on the contents of the gas cylinder and allows a more accurate estimation of the status of the cylinder to be determined.

Inaccurate determination of the status of the cylinder may cause several problems as identified above. For example, cylinders may be changed when they are not empty. Compensating for temperature data mitigates the effect of cold on the cylinder status. Moreover, if a consumer is charged on a per cylinder basis, the consumer pays for gas they have ultimately not used. Throughout the document, the term “consumer” includes commercial businesses (typically restaurants and hotels), private residences (typically households), and private individuals. Thus the end customer can be either the commercial type or the private type.

Preferably the processing unit is configured to estimate a percentage of gas in the cylinder from the modified comparison. Estimating the percentage of usable gas left in the cylinder provides a simple way of presenting the user with useful information. Whilst the weight of the cylinder can be calculated and presented to the user, the number will not immediately indicate the useful remaining lifetime of the cylinder to the user. Presenting the user with a percentage is more usefully indicative of the remaining useful lifetime of the cylinder as the user will already have a rough idea of how much use they can get from a cylinder with 50% gas, for example. Instead of providing the user with a percentage of remaining gas, any other useful means of indicating the amount of gas in the cylinder could be used, for example using a set of status bars, or presenting the user with a set of numbers, for example from 1 to 5 where 1 indicates empty and 5 indicates full.

Consumers perceive they have high usage of LPG at low temperatures since the amount of LPG you can get of the cylinder varies with temperature. Thus the system of the invention can improve consumer satisfaction with their LPG supply. Consumer satisfaction is further improved through the payment system being based around the volume of gas the consumer actually uses, rather than on a per cylinder basis as is currently done.

The processing unit may be further configured to apply a regression model to a change in the estimated percentage of gas in the cylinder over a plurality of time intervals, the output of the regression model indicating the status of the cylinder. Alternatively the processing unit may be configured to apply a regression model to a change in the weight data over a plurality of time intervals, the output of the regression model being used to determine the status of the cylinder based on the temperature data.

Using a regression model allows the status of the gas cylinder to be determined on either a change or a rate of change of real-time input data, rather than simply using a current value or a historical value. Thus, that data being input into the regression model is more representative of the current status of the gas cylinder, and so the output of the regression model will therefore be a more accurate representation of the current status of the gas cylinderregression. In some examples, the regression model is a linear regression model. However, any other suitable goodness of fit model could be applied to the data to estimate the status of gas cylinder, for example chi squared fit or least squares fit.

Optionally the status of the cylinder is at least one of the following statuses: full, depleting, empty, or leaking. Being able to categorise the current state of the cylinder into several discrete, easily distinguishable and identifiable statuses immediately allows the user to be able understand what state the gas cylinder is currently in. The user is able to quickly and easily understand the general overall situation without the need to understand complex outputs or interpret numerical values. Advantageously the user can be quickly alerted if something is not right, avoiding potentially dangerous situations. Furthermore, the user, or LPG supplier, can quickly determine when a cylinder is half full and so can order cylinder refills before the cylinder actually runs out of gas.

The processing unit may be configured to estimate when the status of the cylinder is considered to be no longer yielding by comparing a percentage of gas in the cylinder with a minimum threshold value and if the percentage is below the minimum threshold value and remains unchanged for a predetermined time period, provide an indication to the user that the cylinder is no longer yielding gas. In general, a cylinder will stop yielding gas when the pressure inside the cylinder becomes too low and the gas inside the cylinder cannot be forced out of the cylinder and so cannot be used. Being able to estimate when the amount of gas in the cylinder is about to run out allows new cylinders to be ordered before the current cylinders run out, helping to automate logistic planning including routing options and collection times. In combination, the temperature data and a modification of the weight test using the temperature data compensates for the effect of ambient temperature on the ability for the cylinder to yield useful gas.

This ensures that the user does not have to go through a period of no gas, which could negatively affect their business or private residence such as a user's home. Furthermore, since a cylinder may stop yielding gas before it is physically empty the end user may be waiting for a cylinder to empty, based on its weight which would not be the same as its tare weight, and so may change cylinders too late. Being able to estimate when the amount of usage gas in the cylinder has been reached, i.e. when the cylinder stops yield, allows changes in environment, for example different temperatures, to be taken into account which affects when the cylinder stops yielding.

The processing unit may optionally be configured to estimate when the status of the cylinder is considered depleting by identifying a change in percentage of gas over a predetermined time period, comparing the percentage of gas in the cylinder with a reference value and an upper threshold value and if the percentage is less than both the reference value and the upper threshold value, provide an indication to the user that the cylinder is considered to be depleting.

Estimating when the cylinder starts depleting is important as it indicates to the end user that the cylinder has been connected correctly and is operating properly. In addition, determining that the cylinder has started depleting indicates that the switch has correctly deactivated an empty cylinder and switched to a full cylinder, confirming normal operation of the cylinder installation as well as helping to provide an estimation as to when the full cylinder will run out. Furthermore, providing an indication that the cylinder is depleting may be used to flag unauthorised usage of the cylinder to the user if the cylinder is depleting at a time when it should not be depleting, for example overnight. This may be particularly relevant for businesses, such as restaurants, which are generally not using large volumes gas (for example in the kitchen for cooking) at night. However, heating a building or premises may take place during the night and so, in this case, a user would expect a reduced volume of gas to be used during the night compared to gas usage during the day. Comparative day and night gas volumes would therefore indicate a leak or unauthorised usage of gas. Error detection may also sound alarm that could also be used, for gas leak, error in installing, wrong side of switch, theft etc. and also to inform a consumer and other relevant authorities.

The processing unit may optionally comprise a machine learning model or deep learning model. In certain embodiments the processing unit may optionally comprise neural network, such as a recurrent neural network, trained on test data, the neural network configured to receive the input parameters, operate on the input parameters, and output a status of the gas cylinder based on the operation performed on the input parameters. Here, a neural network is an example of a machine learning technique that may be implemented in the system. However, any machine learning or deep learning technique may be used to provide advantages of that specific machine learning algorithm, in particular the ability to accurately predict when a gas cylinder is going to run out of usable gas.

An advantage of using a machine learning technique, such as a neural network, is that the machine learning technique implemented may be self-learning and adaptive, enabling it to take into account new information that is learned over time. The machine learning technique therefore uses the most up to date information and knowledge about the parameters to estimate the status of the cylinder. As explained previously, this can help predict when a cylinder is going to run out of gas, helping to optimise cylinder delivery and collection times, as well as allowing a payment method to be implemented which is based around charging a consumer for the volume of gas used rather than the number of cylinders delivered. As this information changes and more data becomes available over time, the machine learning technique, such as a neural network, is able to adapt its operating step and provide a more accurate output. Additionally, these techniques, in particular neural networks, are well suited to identifying anomalies and categorising events within signals. This means that the chosen machine learning technique is well suited to identifying abnormal usage, or faults, with the cylinder, based on the signals received from the sensors. Advantageously, the use of machine learning, including neural networks, provides a self-improving prediction system for accurate prediction of normal and abnormal gas usage.

The set of input parameters includes all input parameters that are relevant to the calculation. For example, the set of input parameters may further include one or more selected from a group comprising: estimated percent of gas in the cylinder at a first time; weight of the cylinder at the first time; cylinder tare weight; certified control weight; opening hours of a property where the cylinder is installed; a depletion status of the cylinder indicating whether the cylinder is currently depleting or currently paused; a time since the last known time the cylinder was depleting; aggregated information about typical weight for the cylinder when it stops yielding gas; weather conditions, including temperature data; and signals from at least one additional local sensor including: ultrasound sensor, external temperature sensor, infrared temperature sensor, and flowmeter. Such a combination of weighted input parameters provides for an accurate identification of the status of the cylinder and further enables the system to accurate predict when the cylinder may be expect to no longer yield gas to the system despite fluid being present in the cylinder.

The depletion status may be determined by calculating a rate of change of the received weight data over a time period. A negative rate of change may indicate that the cylinder is depleting. Further, the system may then be able to extrapolate this information to crudely estimate when the cylinder may be fully depleted.

A depletion status may be determined using a set of weighted input parameters including: a plurality of smoothed and filtered weight data measurements over a time period; cylinder tare weight; a maximum weight of the cylinder; and, a typical depletion rate. These input parameters may be provide an accurate indication that the monitored side is depleting and therefore the unmonitored side of a parallel LPG configuration may be no longer yielding gas and needs replacing. By “monitored side”, we mean a group of at least one cylinder with which the load sensor is associated. By “unmonitored side”, we mean a group of at least one cylinder which is not associated with a load sensor. This concept will be explained in more detail later.

The processing unit may be configured to estimate the percentage of gas at a first time period and second time period and calculate a difference between the percentage of gas at the first and second time periods, the processing unit subsequently configured to compare the difference with a lower reference value and if the difference is substantially equal to the lower reference value, provide an indication to the user that the cylinder is considered to be in a period of inactivity. In other words, if the percentage of gas in a gas cylinder has not changed over a particular period of time then it can be assumed that the gas cylinder was not depleting during that time period (i.e. the gas in the cylinder was not being used). Estimating when the cylinder is in a period of inactivity allows the chosen machine leaning or statistical technique model, for example a neural network, to collect and learn information about typical usage patterns of the end user. The use of machine learning allows the overall system to better predict when the status of the cylinder will become empty as it can take into account inactive period which appear during the users normal business hours. As well as improving the estimation of when the cylinder will become empty (and subsequently the optimal time for changing the cylinder), this will also enable unusual events to be detected. This is because if the cylinder is considered to be inactive at a time it is typically considered active, a supplier can be informed that either a sensor may not be working correctly or the cylinder may have been installed incorrectly causing the sensors to receive inaccurate signals. In addition, it is possible to indicate the possible theft of a cylinder if it appears that the cylinder is inactive during a time when it is usually considered active.

The processing unit may be configured to compare the difference with an upper reference value and if the difference lies between the upper threshold value and the lower threshold value, provide an indication to the user that the cylinder is considered to be leaking.

Leaking gas within the system is dangerous and so it is important to be able to detect this status so that it can be corrected as soon as possible. Here, the “leaking” status indicates that gas is leaking from the system but does not indicate the exact point in the system from which the gas is leaking. For example, gas may potentially leak from a cylinder, a pipe, or through a damaged gas outlet such as a stove top but the leaking status is not able to distinguish between these different leaking points.

As an example, a cylinder may be leaking because it has not been installed correctly or because it is a counterfeit cylinder which does not connect properly to the rest of the gas pipeline. A leaking cylinder could also indicate a faulty cylinder or pipes or other leaks. Indicating a leak to the user therefore allows the situation to be investigated as soon as possible, reducing the chance of hazardous situation arising. This improves the safety of the cylinder installation.

Preferably the processing unit may be configured to retrieve historical data and the determination of the status of the cylinder may be carried out on the historical data. Here, aA cloud based server is may be used to store the historical data, the term a cloud-based server may refer to a server that is built, hosted, and delivered through a cloud computing platform over the Internet. Thus, instead of being hosted on physical hardware, they reside in a shared “virtual” environment. Cloud based servers possess similar capabilities and functionalities to typical servers but they are accessed remotely from a cloud service provider. If a sensor fails it is important to still be able to estimate the status of the cylinder so that the user does not have to go through a period with no gas, which could cost them business. In order to estimate the status of the cylinder, historical data that may be collected when the sensor was working can be used to extrapolate the data from the point in time when the sensor failed. This ensures that the processing system is still able to estimate the cylinder status. Historical data may be constantly updated during periods when the cylinder is working so that large amounts of data are available for the extrapolation. Advantageously this allows unusual events, for example holidays, to more accurately be able to be taken into account, even when the sensor has failed and is not providing real time data to the processing unit.

The processing unit may be remote from the gas cylinder and its sensors i.e. the temperature and load sensors. Despite being remote from the cylinder and sensors, the processing unit is still in communication with the load sensor and temperature sensor, the load sensor and temperature sensor being local to the gas cylinder. Having the main processing unit remote from the cylinder reduces the size of the system at the user end. Since it is only the processing unit which is responsible for performing the status determining calculations, and not the temperature sensor or load sensor, it is possible for the processing unit to be separated from the sensors, as long as it can communicateion with them. This means that the user does not have to dedicate large amounts of space to the status determination system which could be costly. The system can therefore be used by users with small premises and is not restricted to large commercial properties.

In certain embodiments the indication about the status of the cylinder is provided to the user via a display screen of a portable computing device. This provides and simple and convenient way of informing the user of the status of the cylinder. If the user has the portable device with them, it allows the user to be informed immediately about the status of the cylinder even if the user is not local to the cylinder. This ensures that the user can be informed of any potential problems as soon as they arise which can reduce the change of dangerous situations arising. Furthermore a supplier can be quickly and easily informed of the status of the gas cylinder at the consumer site and can pre-order more cylinders accordingly. This can be done either manually or automatically by the system.

Preferably and advantageously the system may comprise a plurality of cylinders wherein the load sensor is associated with only one of the plurality of cylinders and wherein the processing unit is further configured to estimate the status of the plurality of cylinders. By “associated” we mean that the load sensor is functionally connected to a cylinder. In some cases, the load sensor is in direct contact with its associated cylinder. For example, the cylinder that is associated with the load sensor may be placed on top of the load sensor. In other cases the load sensor is in indirect contact with its associated cylinder. For example, the cylinder may be placed upon a stand or frame, the load sensor being underneath this stand or frame.

Using only one sensor to monitor the status of all the cylinders reduces the complexity of the overall status determining system. In addition, this reduces the amount of space needed to install the status determination system as there are few additional components to the user's normal cylinder setup. This has the added advantage of reducing the costs and time needed to install the cylinders.

The status of one cylinder may be used by the processing unit to estimate the status of other cylinders at the same location and connected to the same equipment by knowing when the monitored cylinder is empty and when it is depleting. This is possible because the status of all the cylinders in the plurality of cylinders is the same. For example, all the cylinders are either full, depleting, or empty.

The plurality of cylinders may be thought of as an array of cylinders, each array comprising at least two cylinders. The plurality of cylinders may be arranged into at least two distinct groups. In this case, the plurality of cylinders may be thought of as a double array of cylinders, wherein each array corresponds to a group. Each group may comprise at least one cylinder. The groups may be separated by a switch, the switch determining which group of cylinders is in fluid communication with the pipelines of the system. The groups can be thought of as being “connected”/“on” (i.e. the switch is in an on position which means that the cylinders are in fluid communication with the pipelines of the system) or “disconnected”/“off” (i.e. the switch is in an off position which means that the cylinders are not in fluid communication with the pipelines of the system). Each group or array may deplete in parallel, with each cylinder in the group depleting at substantially the same rate. Said another way, all the cylinders within a particular array, or group, are connected together so that all the cylinders within that array are providing the same amount of gas to the system.

As before, the statuses of all the cylinders within a group/array are the same. However, the statuses of the cylinders in separate groups/arrays may be different. When two or more arrays of cylinders are separated by a switch, the status of all the “connected” cylinders are the same within that array and the status of all the “disconnected” cylinders are the same within that array. It should be noted that the status of the “connected” array and “disconnected” arrays may be different from each other. For example in a first group of at least one cylinder, the status may be “full”, whilst in a second group of at least one cylinder the status may be “depleting”.

The load sensor may be associated with only one of the groups/arrays of cylinders. For example, the load sensor may be associated with a first group of cylinders while a second group of cylinders does not have a load sensor associated with it. The load sensor may be associated with only one of the cylinders in the one group (this meaning the weight of one cylinder of one group/array). For example, the load sensor is associated with a first cylinder in the first group of cylinders while a second or any further cylinders within the first group are not associated with the load sensor. Thus, the system may comprise a plurality of groups/arrays of cylinders but only one load sensor. For example, a system having a double array of cylinders (i.e. a first and second array of cylinders, the two arrays being separated by a switch) requires only one load sensor, the load sensor being associated with only one of the arrays in the double array.

The load sensor may be directly associated with a first group of cylinders and indirectly associated with a second group of cylinders, via the first group of cylinders. By this we mean that the load sensor can directly measure the weight of a cylinder, or a plurality of cylinders, within the first group, this cylinder or plurality being the cylinder that the load sensor is associated with, and indirectly measure the weight of a cylinder, or plurality of cylinders, in the second group based on information and data deduced from the cylinder in the first group. This deduction and calculation typically takes place during cylinder replacement events.

In certain embodiments the processing unit may also estimate when the status of the cylinder is considered full by comparing the percentage of gas in the cylinder with a reference value and if the percentage is above the reference value, provide an indication to the user that the cylinder is considered to be full. Estimating when the cylinder is considered full indicates that a switch from an active side to a passive side has been made and that the cylinder on the passive side needs to be replaced. By “active” side we mean a group of at least one cylinder which is currently depleting. By “passive” side we mean a group of at least one cylinder which is not currently depleting. In this case, a “passive” group could be either of group of at least one cylinder which is full and has not yet started depleting gas, or a group of at least one cylinder which is empty and has already been depleted of gas. When a cylinder group is actively depleting gas, its overall weight will decrease with time as the gas is supplied to the pipelines. When a cylinder group is not depleting i.e. is passive, its overall weight will remain constant with time. Thus, the rate of change of weight of a particular group of cylinders can be used to determine whether than group is an active or passive group.

By indicating a full status, the gas supplier is able to deliver new cylinders to the user before the user runs out of gas. The supplier can therefore change the cylinders on the passive side of the installation while the full cylinders on the active side are being used. The user is therefore kept in constant supply of gas.

With the following implementations, it may be possible to run an entire cylinder group/array in parallel. This makes the gas last twice as long until they are all empty, which in turn halves the transport costs. A switch may not be necessary. That is, one can safely run things in parallel if one is allowed to replace cylinders possibly a while before they are empty (without loss of gas for the customers). Running things in parallel, one has no safety in the form of an additional array of cylinders.

The processing unit may also be configured to retrieve a certified control weight of the gas cylinder and use the certified control weight to calibrate the step of determining the status. The certified control weight is the weight of the cylinder filled with gas, as measured at the point (i.e. at the time and location) where the cylinder was initially filled with gas. Thus, the certified control weight represents the initial starting weight of the cylinder. An advantage of using the certified control weight is that it represents an approved weight of each gas cylinder, for example approved by the LPG supplier or distributor. This control weight therefore represents the “correct” starting amount of gas in each cylinder. The certified control weight can therefore be used to indicate whether an individual cylinder was under-filled with gas, over-filled with gas, or has leaked during transportation, because the total weight of the cylinder will be different to the certified control weight of the cylinder. This allows the system to be calibrated to the actual starting weight of the cylinder, rather than using the perceived or expected start weight of the gas cylinder. Calibrating the load sensor ensures that accurate estimations of the weight of the cylinder can be made. Advantageously, this may provide improved error detection, for example leak detection, if the system is able to more accurately estimate the weight of the cylinder.

The certified control weight can also be used to verify that the cylinder is a genuine cylinder provided by a regulated body, rather than a counterfeit cylinder. The certified control weight therefore improves the safety and security of the status determination system. In addition, accurate determination of the percentage of gas in the cylinder, based on accurate estimation of the weight of the gas cylinder, allows the user to be charged based on the actual amount i.e. volume of gas they have used, rather than being charged for a complete cylinder. Charging the consumer on a volume of gas used basis, rather than a per cylinder basis, therefore means that the consumer is more accurately charged for the gas that they have actually used, rather than the gas that they have received from the supplier but not necessarily used. Thus, the certified control weight provides cost saving advantages for the consumer.

The use of a certified control weight in the above described system means that suppliers and distributors can be more flexible in terms of when they change cylinders because the remaining gas will be subtracted from the end-users fee. This, in turn, means that distributors can optimize routing logistics on a more per-region basis, as they now no longer have to reactively deliver to empty customers, but instead can proactively deliver to all customers in a region close to being empty (where “close” is defined as having so little gas that they will become empty before the next estimated batch of deliveries). Furthermore, one can now start optimizing the number of cylinders present at each end-consumer location such that consumers in close proximity to each other empty their cylinders at roughly the same pace. Thus, potentially all consumers in the same region will have empty cylinders at approximately the same, which is a huge logistics optimization as well as the potential for reducing the logistic costs.

The cylinder comprises a machine readable identification tag comprising unique information to identify the cylinder and wherein the processing unit is configured to receive the identification tag applied to the cylinder and associate the unique information with the received weight data and temperature data. Additionally, the unique information identifying the cylinder can be associated with the tare weight of the cylinder.

The machine readable tag may be an RFID tag or a QR code, however any other suitable technology could be used such as, Narrowband Internet of Things technology (NB-IOT), which is a Low Power Wide Area Network (LPWAN) radio technology standard. Advantageously, this ensures that each cylinder can be correctly identified. The tag may be read, or scanned, by a machine or system at the supplier end or the consumer end. Thus, as well as being able to track the cylinder, the ID tag ensures security of the delivery of the cylinder when it is scanned as both the supplier and the consumer will know whether the delivery of the cylinder has been successful or if something may have happened to the cylinder, such as theft, on route. If any cylinders go missing then the supplier can be immediately alerted because the cylinder information will not be scanned into the system. Since gas cylinders are valuable, the identification tag allows the cylinder to be tracked and monitored during delivery, reducing the change of them being stolen. By “tracked” we mean that it is generally known whether the cylinder has entered or left the system as a whole. For example, whether a cylinder has left a supplier or has been receiver at the consumer end. In other words, the tracking system indicates whether a cylinder has been lost or not. It does not mean that a geographical location, for example GPS coordinates of the cylinder, are known. Thus, the geographical location of the cylinder within the system is not determined. Instead, the cylinder is linked with the geographical location of the supplier or the end-consumer. Linking the cylinder to the stored information received from the supplier ensures that the correct certified control weight and tare weight are used for each cylinder.

In addition, if the cylinders do get stolen, have a tracking and identification system on the cylinders increases the likelihood of the cylinder being found and returned to either the consumer or the supplier. The sensor may include a tracking system reader. This may be an RFID reader. The tracking system reader may read the ID tags on the cylinders and send signals wirelessly to a central processing unit, which may be a processing unit on the cloud-based server. These singles may be used to inform the supplier of exactly which cylinders have been distributed to which customers.

The processing unit may also be configured to retrieve a plurality of input parameters including the weight data and temperature data, apply a weight to each input parameters to generate a set of weighted input parameters and sum the weighted input parameters to identify the status of the cylinder.

Weighted parameters advantageously allow the model to take into account the relative importance of different parameters on the measured weight. Applying a weight to the parameters allows therefore allows prior knowledge of the importance or significance of the parameter to be included in the estimations. More important parameters can have a large weight applied and less important parameters can have a lower weight applied. This reduces the chance of less significant parameters skewing the data which may provide inaccurate estimations of the status of the gas cylinder. Furthermore, the weight of the parameters can be modified overtime as knowledge about the parameters changes. Advantageously, this allows the model to take into account situational changes over time and continue to provide accurate estimations of the status of the cylinder.

According to a further aspect of the invention there may be provided a system for managing deployed gas cylinders in commercial premises, the system comprising at least one local sensor unit and a processing unit, wherein the at least one local sensor unit comprises a weight sensor configured to determine a weight of a cylinder and a wireless transceiver and the at least one local sensor unit is configured to send weight measurements at predetermined time intervals to the central remote processing unit; and wherein the processing unit is configured to: receive weight measurements from the local sensor unit; receive a plurality of unique electronic identifiers, each associated with a respective cylinder of a set of cylinders deployed in a commercial premise; identify a local sensor unit associated with the commercial premises from the at least one local sensor unit; associate the weight measurements received from the identified local sensor unit with one of the plurality of unique electronic identifiers; and, determine a status of each of the set of cylinders from the weight measurements and associate the status with a respective unique identifier. The system is able to accurately identify the status of an unmonitored cylinder from a remote location to enable remote monitoring of LPG deployments.

In some cases the processing unit is a remote processing unit, by which we mean that the processing unit does not form part of the cylinder or any of the sensors. In this case, the remote processing unit is able to communicate with the temperature and load sensors to transfer data between the processing unit and the sensors. As above, the remote processing unit may be distributed. Preferably the processing unit is further configured to: receive a certified control weight; retrieve a weight of each of the set of cylinders associated with a unique identifier uniquely identifying each cylinder of the set of cylinders; compare the certified control weight with the weight of each of the set of cylinders; and, calculate an amount of gas used by commercial premises from the plurality of comparisons. Customers may be charged for actual usage of gas (either in real-time of after the event) which has hitherto not been achievable as it has not been possible to accurately link the cylinder in use with the customer who used that gas and accurately determine the gas used. Currently gas is charged on a per cylinder basis which is not preferable for consumers.

The processing unit may be further configured to: monitor the weight measurements over a predetermined time period; predict an estimated usage of gas from the monitored weight measurements; and, report the prediction. By accurately being able to identify when a set of cylinders may no longer yield gas, the proposed system enables the reduction of stored gas at the commercial premises which improves security and impact when an error arises as there is no longer a need for significant reserves. Further, the system may facilitate a reduction in the number of spare cylinders that need to be stored on site and thus increased safety and less bound capital.

In certain embodiments the processing unit may be further configured to: modify the prediction based on one or more input parameters selected from a group comprising: a cylinder temperature, the cylinder temperature being received by the processing unit from the local sensor unit; an ambient temperature of the local sensor unit, the ambient temperature being received by the processing unit from the local sensor unit; a weather forecast for the commercial premises; historical data of usage of the commercial premises; a calendar of upcoming events likely to impact usage; change in weight measurements from local sensor units of the plurality of sensor units; and signals from at least one additional local sensor including: ultrasound sensor, external temperature sensor, infrared temperature sensor, and flowmeter. The use of these input parameters enables an accurate prediction to be made based on a series of data sources which each improve the overall accuracy of the prediction. By knowing both the local cylinder temperature and weather data prognosis, one can predict the temperature gradient and potential change in LPG usage. This has the additional benefit that logistics surrounding the collection of empty cylinders and the delivery of new cylinders (for example route planning between multiple consumers and delivery/collection times) can be optimised through better prediction of gas usage. Furthermore, a consumer can be more accurately charged for their gas as a payment model can be constructed around the actual volume of gas used, rather than the number of gas cylinders delivered, as explained previously.

In preferred embodiments the processing unit is configured to apply the input parameters to a trained machine learning model or statistical model to predict the estimated usage. The trained machine learning model may be a neural network, deep learning model or other suitable statistical model. In examples, the input parameters could for example be the input layer of the network, a hidden layer applies a weight to each input parameter and an output layer outputs a prediction of estimated usage. Thus the system is able to accurately learn and predict the usage in an improved manner.

The processing unit may be further configured to compare the estimated usage against a delivery database and generate an order message indicating a delivery date to replace at least one of the set of cylinders at the commercial premises.

An important benefit of using the automated system of the present invention is that the deliveries are automatically detected at the customer location. This eliminates the need for the driver and administration to manually register the order into the main management system when the deliveries are completed. Automatic detection of deliveries will also remove the risk of human errors that exist in the current manual process. Further, drivers' routes can be automatically and continuously optimised to reduce the manual load, decrease cost and improve environmental footprint. Further the logistics of the ecosystem can be optimised.

The local sensor unit of this aspect of the invention may further comprise one or more temperature sensors which may be configured to send temperature data from the temperature sensor to the processing unit, and the processing unit may be the processing unit of the first aspect of the invention. The one or more temperature sensors may include one of a local temperature sensor to measure the temperature of the cylinder (or very close i.e. local to the cylinder) and/or an ambient temperature sensor to measure the temperature of the general atmosphere and region in which the cylinder is located. Other local sensors may be provided to improve data calculations such as ultrasound sensors to determine fluid volume, air pressure sensors and flow meters.

According to a further aspect there is provided a method of determining a status of a gas cylinder, the method comprising the steps of: detecting a weight of the cylinder, using a load sensor, at predetermined time intervals; detecting a temperature local to the cylinder, using a temperature sensor, at the predetermined time intervals; receiving, by a processing unit, weight signals and temperature signals from the load sensor and temperature sensor respectively; determining, by the processing unit, the status of the gas cylinder based on the received weight and temperature signals; and indicating to a user the stats of the gas cylinder.

Preferably, the method further comprises the steps of: receiving, by a transceiver, signals from the load sensor and the temperature sensor, the signals corresponding to weight data and temperature data respectively; and sending, by the transceiver, the weight data and temperature data to the processing unit.

The method may further comprise: retrieving, by the processing unit, a tare weight; calculating, by the processing unit, a difference between the tare weight and the received weight data to determine a weight difference; comparing, by the processing unit, the weight difference with a threshold value; and modifying, by the processing unit, the comparison using the received temperature data.

Preferably the method comprises estimating, by the processing unit, a percentage of gas in the cylinder from the modified comparison.

Preferably, the method further comprises applying a regression model to a change in the estimated percentage of gas in the cylinder over a plurality of time intervals, the output of the regression model indicating the status of the cylinder.

Preferably the method further comprises applying a regression model to a change in the weight data over a plurality of time intervals, the output of the regression model being used to determine the status of the cylinder based on the temperature data.

In some cases, the regression model may be a linear regression model.

The method may comprise estimating when the status of the cylinder is considered to be no longer yielding by comparing a percentage of gas in the cylinder with a minimum threshold value and if the percentage is below the minimum threshold value and remains unchanged for a predetermined time period, indicating to the user that the cylinder is no longer yielding gas.

The method may comprise estimating when the status of the cylinder is considered depleting by identifying a change in percentage of gas over a predetermined time period, comparing the percentage of gas in the cylinder with a reference value and an upper threshold value and if the percentage is less than both the reference value and the upper threshold value, indicating to the user that the cylinder is considered to be depleting.

The method may comprise the steps of: estimating the percentage of gas at a first time period and second time period and calculating a difference; comparing the difference with a lower reference value; and indicating to the user that the cylinder is considered to be in a period of inactivity if the difference is substantially equal to the lower reference value.

Preferably the method comprises the steps of: comparing the difference with an upper reference value; and indicating to the user that the cylinder is considered to be leaking if the difference lies between the upper threshold value and the lower threshold value.

The method may comprise retrieving historical data from a cloud-based server and determining the status of the cylinder based on the historical data.

Indicating the status of the cylinder to the user may be via a display screen of a portable computing device.

The method may comprise associating the load sensor with only one cylinder of a plurality of cylinders and estimating the status of the plurality of cylinders.

The method may comprise retrieving a certified control weight of the gas cylinder and using the certified control weight to calibrate the step of determining the status.

The cylinder may comprise a machine readable identification tag comprising unique information to identify the cylinder, and wherein the method may comprise the steps of receiving by the processing unit the identification tag applied to the cylinder and associating the unique information with the received weight data and temperature data.

The method may further comprise retrieving a plurality of input parameters including the weight data and temperature data; applying a weight to each input parameters to generate a set of weighted input parameters; and summing the weighted input parameters to identify the status of the cylinder.

Preferably the processing unit may comprise a neural network trained on test data and the method may comprise: receiving by the neural network the input parameters; operate on the input parameters; and outputting a status of the gas cylinder based on the operation performed on the input parameters.

Determining the depletion status may comprise calculating a rate of change of the received weight data over a time period.

Determining the depletion status may comprise using a set of weighted input parameters including: a plurality of smoothed and filtered weight data measurements over a time period; cylinder tare weight; a maximum weight of the cylinder; and a typical depletion rate.

According to another aspect there is provided a method for managing a system of deployed gas cylinders in commercial premises, the system comprising a plurality of local sensor units and a processing unit, wherein the at least one local sensor unit comprises a weight sensor configured to determine a weight of a cylinder and a wireless transceiver and the at least one local sensor unit is configured to send weight measurements at predetermined time intervals to the processing unit; the method comprising the steps of: receiving by the processing unit weight measurements from the local sensor unit; receiving by the processing unit a plurality of unique electronic identifiers, each associated with a respective cylinder of a set of cylinders deployed in a commercial premise; identifying by the processing unit a local sensor unit associated with the commercial premises from the at least one local sensor unit; associating by the processing unit the weight measurements received from the identified local sensor unit with one of the plurality of unique electronic identifiers; and determining by the processing unit a status of each of the set of cylinders from the weight measurements and associating the status with a respective unique identifier.

The method may further comprise: receiving a certified control weight; retrieving a weight of each of the set of cylinders associated with a unique identifier uniquely identifying each cylinder of the set of cylinders; comparing the certified control weight with the weight of each of the set of cylinders; and calculating an amount of gas used by commercial premises from the plurality of comparisons.

The method may comprise: monitoring the weight measurements over a predetermined time period; predicting an estimated usage of gas from the monitored weight measurements; and reporting the prediction.

Preferably, the method further comprises: modifying the prediction based on one or more input parameters selected from a group comprising: a cylinder temperature, the cylinder temperature being received by the processing unit from the local sensor unit; an ambient temperature of the local sensor unit, the ambient temperature being received by the processing unit from the local sensor unit; a weather forecast for the commercial premises; historical data of usage of the commercial premises; a calendar of upcoming events likely to impact usage; change in weight measurements from local sensor units of the plurality of sensor units; and signals from at least one additional local sensor including: ultrasound sensor, external temperature sensor, infrared temperature sensor, and flowmeter.

Preferably the method comprises applying the input parameters to a trained machine learning model or statistical model to predict the estimated usage.

The trained machine learning algorithm may for example be a neural network such that the input parameters are the input layer of the network and the method may comprise applying a weight by a hidden layer to each input parameter and outputting by an output layer a prediction of estimated usage.

The method may comprise comparing the estimated usage against a delivery database and generating an order message indicating a delivery date to replace at least one of the set of cylinders at the commercial premises.

The local sensor unit may further comprise a temperature sensor and the method may comprise sending temperature data from the temperature sensor to the processing unit, wherein the processing unit is the above described processing unit.

According to another aspect there is provided a computing device comprising at least one processor configured to perform the above described method.

According to another aspect there is provided a computer readable storage medium comprising instructions, which, when executed by at least one computer processor, cause the at least one computer processor to carry out the above described method.

In summary, a system is proposed to accurate identify the status of an LPG cylinder, accurately identify the status of an unmonitored cylinder, predict the estimated usage of a set of cylinders, track cylinders and accurately associate usage of a cylinder with a commercial premises and predict usage of a set of cylinders to optimise a logistics system.

Advantageously, the system of the present invention allows the amount of gas being used by a consumer to be estimated, and presented to the consumer, so that the time at which refills need to be ordered can be more accurately predicted. Use of estimation and prediction data provides an optimized logistics system including fewer and more efficient delivery trips.

Additionally, the predication system allows a supplier to sell gas to a consumer on a volume basis rather than a per cylinder basis, resulting in a more accurate payment plan for the consumer.

Furthermore, the prediction system of the present invention requires fewer sensors for multiple cylinders. In particular, the present invention only requires one sensor for multiple cylinders, even when these cylinders are arranged in multiple groups separated by a switch.

### BRIEF DESCRIPTION OF DRAWINGS

Embodiments of the present invention will now be described by way of example only with reference to the following drawings in which:

FIG. 1 is a schematic view of a typical gas cylinder installation;

FIG. 2 is a graph illustrating the typical lifecycle of a cylinder;

FIG. 3 is a block diagram of a status determination system;

FIG. 4 is a schematic view of a gas cylinder installation and a sensor;

FIG. 5 is a perspective view of a sensor;

FIG. 6 is a block diagram of a sensor;

FIG. 7 is an exploded view of a sensor;

FIG. 8 is an exploded view of an electronic housing in a sensor;

FIG. 9 is a flow diagram of a typical gas market workflow;

FIG. 10 is a flow diagram of “pay per cylinder” workflow;

FIG. 11 is a flow diagram of another “pay per cylinder” workflow; and

FIG. 12 is a flow diagram of a “pay per volume” workflow.

### DETAILED DESCRIPTION

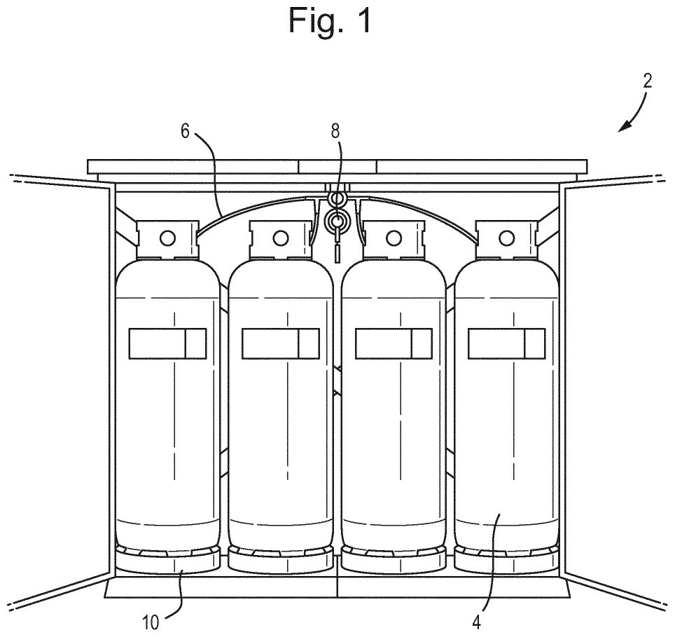

Many industries use LPG as their primary energy source. Some use LPG from large tanks and others use LPG from individual cylinders. A typical LPG cylinder installation 2 for use in industry is shown in FIG. 1, which shows a set of LPG cylinders 4 connected to a pipeline 6. The cylinders 4 are split into two pairs, each pair connected in parallel. Here, a pair is an example of the previously described group or array of cylinders. The two cylinders 4 on the left side of the installation 2 are separated from the two cylinders 4 on the right side of the installation 2 by a switch 8. The switch 8 determines which pair of cylinders 4 is in fluid communication with the pipeline 6 and so determines from which cylinders 4 gas is being supplied at any given time. The switch 8 can be manually or automatically controlled, for example automatically pressure controlled. When one set of cylinders 4 are empty on one side of the installation 2, the switch 8 is either manually or automatically activated and switches to the cylinders 4 on the other full side. For example, when both cylinders 4 on the left hand side run out, the switch 8 will disconnect these cylinders 4 and connect both cylinders 4 on the right hand side so that a continuous supply of gas is provided.

It should be noted that throughout the specification the phrase “cylinder installation” refers to an entire LPG gas set up, including at least one gas cylinder (but more commonly an array of cylinders), pipelines, valves, and a switch (separating the array of cylinders when there is more than one cylinder present).

The terms “group” and “array” are interchangeable are refer to a plurality of cylinders connected together in parallel so that the gas contained in all the cylinders in the group is used at the same time i.e. all the cylinders in a group deplete at the same rate.

A cylinder installation may therefore comprise multiple arrays, separated by the switch.

In a typical cylinder installation 2 the side which is currently depleting, i.e. the side of the installation 2 including the cylinder 4 from which gas is being used to supply the pipeline 6, is known as the active side. The other side of the installation 2 including the cylinders 4 which are not yielding gas to the pipeline 6 is known as the passive side.

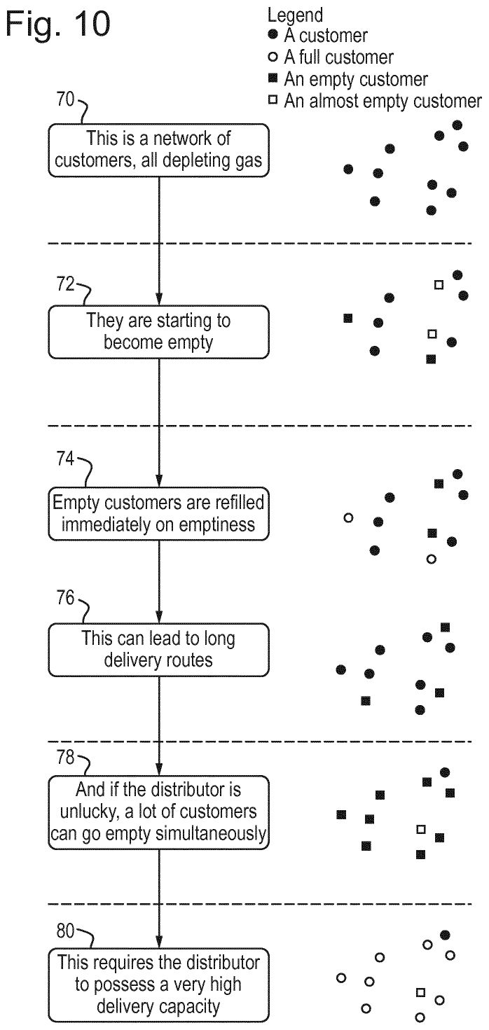

It is common practice to order new full cylinders when the cylinders 4 on one side of the installation 2 are empty or for a provider to replace cylinders periodically. This current workflow is illustrated in FIG. 10. Typically, there is a network 70 of customers who are all actively using cylinders for either private or commercial use. Over time, these cylinders start to become empty 72. The consumer can alert the LPG gas supplier that they are out of gas and require a refill. The supplier then delivers new gas cylinders to the consumer so that they are not left without gas 74. Since not all consumers in the network will use gas at the same rate, the cylinders do not all become empty at the same time. This can lead to long delivery routes 76 as the supplier the consumers requiring new cylinders may not necessarily be located in the same area. There is also the chance that large numbers of consumers run out of gas at approximately the same time 78. The supplier is therefore required to carry large numbers of spare cylinders 80 at any given time so that he can add consumers to his delivery route as he becomes informed of the need to replace a cylinder. As can be seen, this current system is inefficient, results in long delivery times, and requires large volumes of cylinders to be transported around even though they may not all be needed.

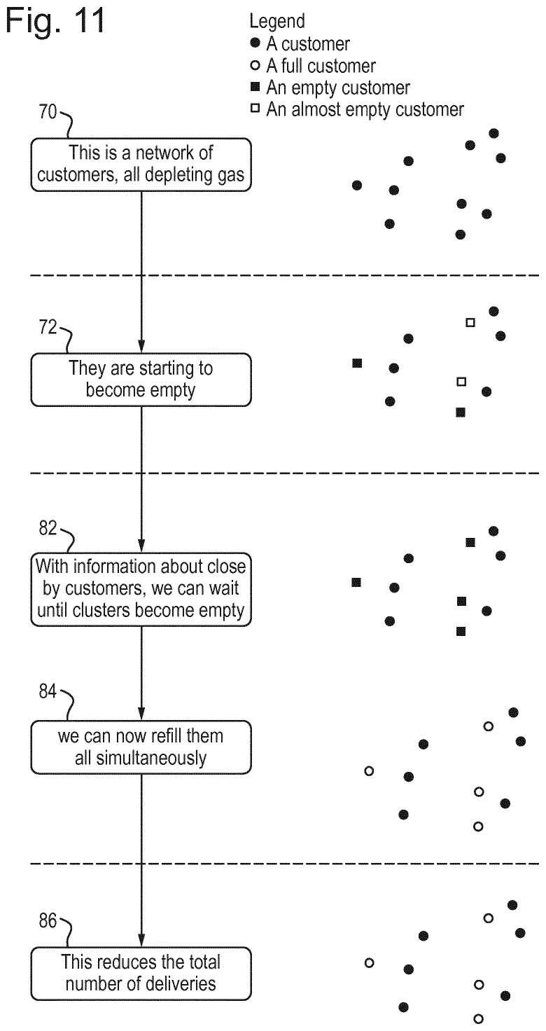

A current attempt to solve this problem is shown in FIG. 11. This workflow differs from that shown in FIG. 10 in that the supplier can collect information about which consumers require cylinder refills, such as the number of cylinders and the consumer's location. The supplier can use this information to wait until all the cylinders within a particular area or cluster are empty 82 so that the empty cylinders can be filled at the same time 84. Whilst this does reduce the total number of deliveries made 86, it leaves some customers without gas for unknown periods of time, which is frustrating for the customer.

A major problem with the workflows shown in FIGS. 10 and 11 is that a provider cannot plan or predict when any given cylinder is going to run out of gas and need replacing. Empty cylinders 4 are typically determined by either the consumer manually checking the status of the switch 8 to see if a switch has been made from the cylinders 4 on one side of the installation 2 to the other or by the consumer experiencing a lack of service and manually activating the switch 8 to switch the cylinders 4. Typically, the cylinders 4 are transported and delivered to the consumer by the LPG supplier. The number of cylinders 4 installed at the consumer site may vary, depending on the requirements of the consumer. Typically, the number of cylinders 4 installed on site is between two and twelve cylinders. Regardless of the number of cylinders 4 on site, the general setup remains the same. That is, the total number of cylinders 4 will be split equally into two groups, the cylinders 4 of each group being connected in parallel. The two groups are connected to the pipeline 6 via a switch 8 and the switch 8 determines from which side of the installation 2 gas is fed into the pipeline 6.

When the cylinders 4 have run out of gas and need refilling, either the empty cylinders 4 can be swapped out for a set of full cylinders 4 or the cylinders 4 can be directly refilled by a LPG truck. The process then continues again. When the currently depleting cylinders 4 no longer yield gas, the switch 8 reverts to the now full other side. The system is manually switched or automatic depending on the installed change over technology.

One complete cycle of the typical process therefore includes the following events:
1. The active side starts depleting for the first time;
2. The active side becomes empty and the switch is turned to use gas from the passive side;
3. The active side now becomes the passive side;
4. The now passive side is refilled while the now active side starts depleting for the first time (refill may occur at any time after the side is empty depending on delivery time etc.);
5. The active side becomes empty and the switch is turned again so that the passive side starts depleting for the second time;
6. The recently emptied side is then refilled.

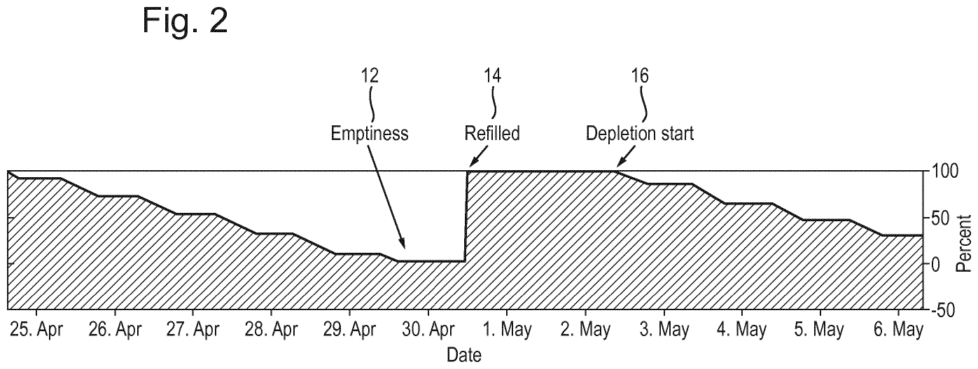

The above described events in a typical cycle are illustrated in FIG. 2. As can be seen, there is a sharp increase in the amount of gas between the cylinder 4 being empty and being refilled, as expected. Once the cylinder 4 has been refilled, it may be some time before the cylinder 4 starts yielding gas, which is illustrated as a plateau representing a constant, unchanging amount of gas in the cylinder 4. Once the cylinder 4 starts depleting, the amount of gas in the cylinder 4 starts to steadily decrease, indicated by the slope in FIG. 2. Interruptions in usage appear as brief plateaus in the amount of gas present in the cylinder 4.

A main problem with current systems is being able to accurately estimate the amount of gas remaining in a cylinder 4 so that the switch 8 in the cylinder installation 2 swaps the cylinders 4 at the optimal time, providing the user with an uninterrupted gas supply. Additionally, current systems do not effectively alert the consumer or suppler to abnormal usage, which might indicate the presence of potentially dangerous conditions at the gas cylinder 4. Finally, current systems do not predict when cylinders are going to run out of gas, making planning deliveries (including delivery routes and delivery/collection times) difficult. A consumer is therefore generally required to keep multiple spare cylinders on site so that they can replace each cylinder as it runs out, rather than waiting for the next delivery of cylinders which may not be optimally scheduled.

The present invention provides a detection system 18 which is able to more accurately determine the amount of gas in a cylinder 4 and its current status, which leads to a more optimal system and better consumer awareness of the current status of the gas cylinder 4.

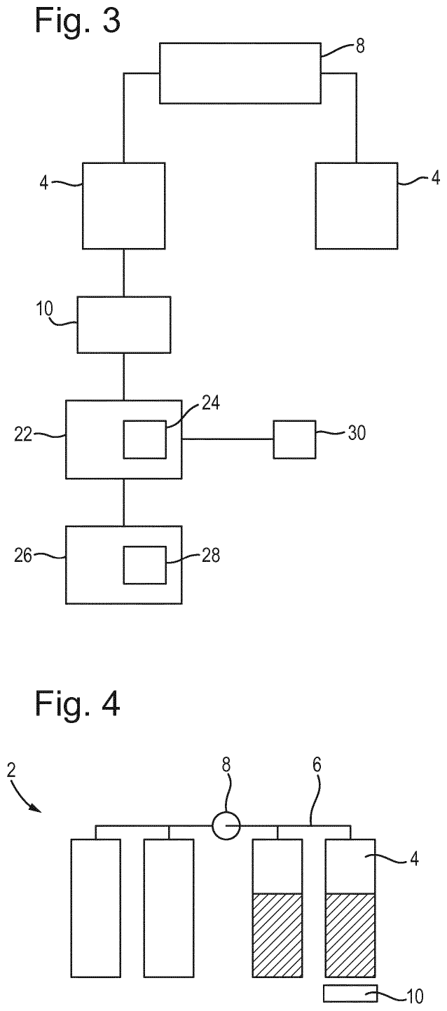

A general status determination system 18 for determining normal and abnormal gas usage is shown in FIG. 3. The system 18 includes a gas cylinder installation 2 comprising a plurality of gas cylinders 4 and a sensor 10. The sensor 10 includes a load sensor 20 which is configured to detect the weight of the gas cylinder 4.

The sensor 10 is in wireless communication with a processing unit 22, which is part of a computer system and remote from the cylinder installation 2. The remote central processing unit 22 includes a processing module 24 which is configured to receive signals from the sensor 10. The signals received from the sensor 10 include weight measurements. The weight of the cylinders 4, which is proportional to the amount of gas present in the cylinders 4, is used to determine when a switch between one side of the installation 2 and the other side of the installation 2 should be made. The weight of the cylinders 4 is therefore monitored, via the sensor 10, during usage. The side of the installation 2, or the cylinder 4, whose weight is being monitored is known as the monitored side. The unmonitored side is the other side of the installation 2, or the other cylinder 4, whose weight is not being monitored. The processing module 24 is configured to determine the volume of gas in the cylinder 4, based on the received weight measurements.

The processing module 24 is also in wireless communication with a cloud-based server 26, which comprises a memory 28 in the form of cloud storage and a database. The database can include historical consumer data as well as other forms of data, which will be explained in more detail later. The processing module 24 sends the volume of gas in the cylinder 4, along with data relating to the time the determination was made, to the cloud-based server 26 for storage. The processing module 24 is also in wireless communication with a user interface 30. The processing module 24 additionally sends the volume of gas left in the cylinder 4 to the user interface 30. The user interface 30 is configured to indicate to the supplier the volume of gas remaining in the cylinder 4, facilitating automatic ordering of new gas cylinders 4.

The system is also operable to estimate the status of the unmonitored cylinders from the status of the monitored cylinder over time so as to identify that the unmonitored cylinders also need replacing. This is possible because once the system has determined that the monitored side has gone from a “full” status to an “empty” status, any further reduction in weight, as measured by the load sensor, must correspond to the unmonitored side depleting gas. Since, the unmonitored side will have started from a “full” status, the system is then able to determine when the unmonitored side becomes empty, as the weight will stop decreasing once the cylinders are empty.

In general, when the monitored side is empty, the system assumes that the unmonitored side will start depleting, and consequently new full cylinders are required on the monitored side. Conversely, when the monitored side is full and starts depleting, the system knows that the unmonitored side must be empty, as the switch has been activated. It is this combination of events which indicates that the cylinders on some side (either the monitored or the unmonitored side) need to be refilled.

Briefly, in use, the sensor 10 is installed and placed under one of the cylinders 4 within the installation 2, on either of the two sides of the cylinder installation 2, as illustrated in FIG. 4. The sensor 10 monitors the weight of the cylinders 4 on one side of the installation 2 and when it is determined that a first set of cylinders 4 is empty, the switch 8 will be manually or automatically changed from the active side that has just been emptied to the other, passive side which contains full cylinders 4. By monitoring the change in gas levels of the cylinder 4 via the sensor 10, the determination system 18 can inform the supplier that the cylinders 4 on one side of the installation 2 are empty and need to be refilled or exchanged. The LPG supplier can then plan their filling routes based on how much gas their customers have left. Thus, the information from the sensor 10 is used to determine when the gas cylinder 4 will be empty to ensure that a new cylinder 4 can be ordered in time.

One complete cycle of the process in an installation comprising one sensor therefore includes the following events:
1. The active monitored side starts depleting for the first time;
2. The active monitored side becomes empty and the switch is turned to use gas from the passive unmonitored side;
3. The active side now becomes the passive side, still being monitored;
4. The now passive monitored side is due to be refilled while the now active unmonitored is being depleted for the first time;
5. The active unmonitored side becomes empty and the switch is turned again so that the passive monitored side starts depleting for the second time;
6. The monitored side then starts depleting while the unmonitored side is refilled.

The status determination system 18 therefore remotely monitors changes in the level of gas in the cylinders 4 and informs the supplier when the cylinders 4 are about to run out, as will be explained in more detail below.

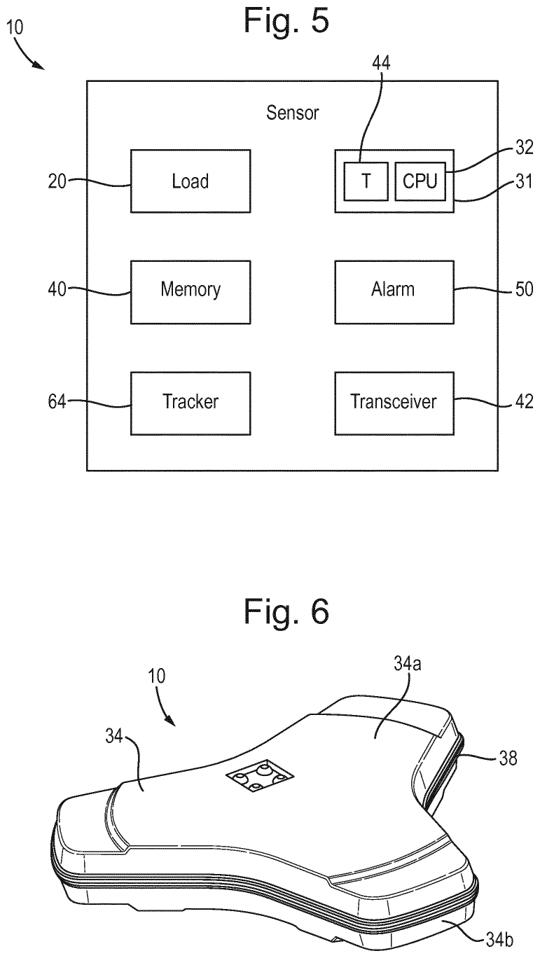

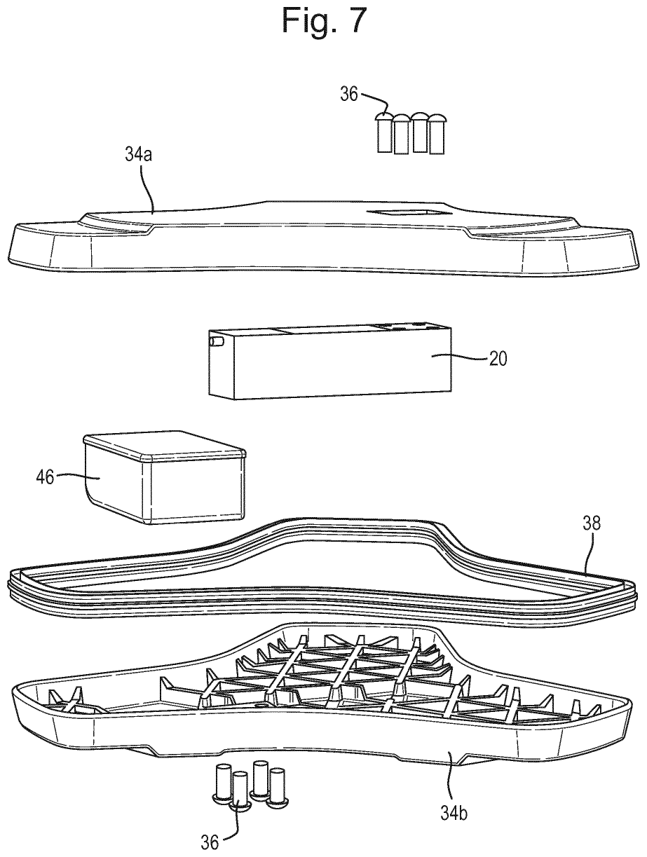

The sensor 10 of the determination system 18 can be more clearly seen in FIGS. 5 and 7. The sensor 10 includes a load cell 20 and a central processing unit (CPU) or microcontroller 32 enclosed within a casing 34. The casing 34 is made from any material that is hardwearing and easy to manufacture, for example plastic. The casing 34 comprises two halves 34a, 34b joined together using any suitable fastening means 36, for example rivets. The two halves 34a, 34b are sealed against the environment by a sealing member 38.

The load cell 20 is a weight sensor 20 which weighs the gas cylinder 4. The weight sensor 20 is configured to monitor the weight of the gas cylinder 4 at predetermined time intervals, for example every 10 minutes. At each predetermined time interval, the sensor 20 detects the weight of the cylinder 4 and stores this information locally on a memory 40 within the sensor 10. At the end of a predetermined time period, for example at the end of each day, the signals from the weight sensor 20 that have been collected and stored are wirelessly transmitted to the remote processing unit 22.

It should be noted that the cylinder installation 2 only includes one sensor 10 that is placed under one cylinder 4 of the installation 2. It does not matter under which cylinder 4 the sensor 10 is placed, or on which side of the installation 2 the sensor 10 is placed. Although the sensor 10 is only placed under a single cylinder 4, it is able to estimate the weight of all the cylinders 4 in the installation 2. This is because the total weight of each cylinder 4 when full is known and so the total weight of all the cylinders 4 in the installation can be determined. In addition, because the cylinders 4 are connected in parallel, rather than in series, the gas usage will be spread equally among the cylinders 4 on the active side of the installation 2. As the sensor 10 knows that only one side is active at any given time, and therefore that only one side of the installation 2 is depleting, the sensor 10 knows that gas usage corresponds to a reduction in weight of the cylinders 4 on the active side of the installation 2. As each side is connected in parallel, all the cylinders 4 on one side will run out at the same time. Thus, once the weight of the cylinders 4 reaches half the initial total weight of the cylinders 4, the sensor 10 knows that the active side has finished depleting and a switch needs to be made.

In order to send the information from the sensor 10 to the processing module 24, the load cell 20 and memory 40 are connected to a transceiver 42 which sends signals from the load cell 20 and memory 40 to the processing module 24 in the remote processing unit 22. The weight sensor is therefore in data communication with the central processing unit 32.

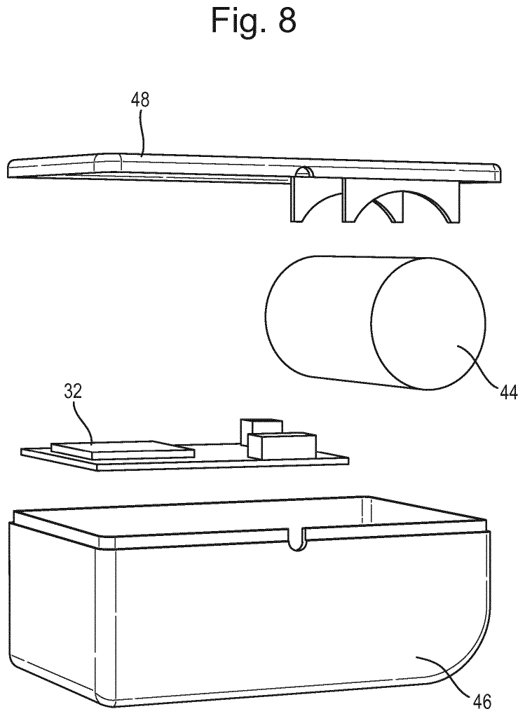

The sensor 10 also includes a printed circuit board (PCB) 31 comprising the CPU 32 and an integrated temperature sensor 44, as illustrated in FIG. 6. The PCB 31 and temperature sensor 44 are contained within a housing 46, as illustrated in FIG. 8. The housing 46 comprises a lid so that the electronic components, including the PCB 31 and temperature sensor 44 can be accessed if needed. Other sensors which may also be present, but are not shown, include an independent thermo-sensor or ultrasound sensor. Similarly, the sensor 10 may be in short range or direct communication with local sensors placed around the housing of the cylinders such as local temperature sensors or flow meters.

The temperature sensor 44 is configured to determine the temperature within the sensor housing and optionally of the atmosphere surrounding the gas cylinder 4 i.e. the ambient temperature. The temperature sensor 44 is therefore configured to detect and determine a temperature local to the gas cylinder 4. The temperature sensor may also be configured to determine the temperature of the cylinder itself by attachment to the cylinder or by close proximity to it. If the sensor is an infra-red temperature sensor as is well known in the art, for example, or a remote thermocouple then it may be possible to accurately determine the temperature of the cylinder itself. The system may also include multiple temperature sensors to input temperature data as parameters. For example, there may be an integrated temperature sensor in the PCB housing, and there may be an additional temperature sensor specifically configured to determine cylinder temperature, cylinder housing temperature, gas temperature, etc.

Measuring the temperature of the gas cylinder 4 is important because the pressure inside the cylinder 4 is proportional to the temperature. Due to the high pressure inside the cylinder, the LPG is stored as a liquid. When an outlet valve on the cylinder is opened, the pressure is released and the LPG leaves the cylinder as a gas. The higher the pressure inside the cylinder, the more gas is released. The ambient temperature surrounding the cylinder will therefore affect the pressure inside the cylinder. For example, warm surroundings will warm up the cylinder which in turn will heat up the contents of the cylinder, increasing the pressure. As the temperature decreases, so does the pressure inside the cylinder 4 and so at cold temperatures the cylinders 4 will yield less gas. Conversely, in warmer temperatures the pressure inside the cylinder will increase and sob each cylinder 4 will yield substantially all of the gas in the cylinder 4. The amount of available gas in the cylinders 4 is therefore temperature dependent. The status of the gas cylinder is therefore determined using both the detected weight of the cylinder data and a detected temperature local to the cylinder.

The temperature sensor 44 is configured to monitor the temperature surrounding the cylinder 4 at predetermined time intervals. These time intervals are the same as the time intervals used to monitor the weight of the cylinder 4, for example every 10 minutes. Optionally, the temperature may be measured less frequently as it is less susceptible to change, than the weight of the cylinder, over time. At each time interval, the sensor 44 detects the temperature of the atmosphere surrounding the cylinder 4 and stores this information locally on the memory 40 in the sensor 10. At the end of a predetermined time period, the signals from the temperature sensor 44 that have been collected and stored are transmitted to the remote processing unit 22. The predetermined time period is the same as the time period used to send the weight signals. Thus, the weight and temperature signals are monitored and sent at the same time.

In order to send information from the temperature sensor 44 to the remote processing unit 22, the temperature sensor 44 is also connected to the transceiver 42 which sends signals from the temperature sensor 44 and the memory 40 to the processing module 24 in the remote processing unit 22. The temperature sensor 44 is therefore in data communication with the remote processing unit 22.

The transceiver 42 in the sensor 10 wirelessly communicates with the remote processing unit 22. The transceiver 42 sends signals using any readily available network connection, for example using General Packet Radio Service (GPRS) within the Global System for Mobile (GSM) communication system. However, any other communication system that is able to communicate with GSM units can be used.

The remote processing unit 22 receives signals from the sensor 10, including signals from the weight sensor 20 and temperature sensor 44, and stores the received signals on a memory or database as appropriate. The received signals correspond to measurements taken by the sensors and therefore include weight data and temperature data.

The processing module 24 retrieves a tare weight of the cylinder 4 from the cloud-based server 26 and, based on the tare weight, the remote processing unit 22 then processes the received data signals, using the processing module 24, to accurately determine the volume of gas present in the cylinder 4. The processing is performed using a number of different algorithms which may for example utilise a neural network, as will be explained in more detail later. The calculation may be based on the LPG weight rather than tare weight. The LPG weight may always the same for a specific cylinder type (e.g. 47 kg). The total weight=tare weight+LPG weight, so we estimate the tare weight by tare weight=total weight−LPG weight.

It should be noted that the tare weight (including additional weight from cables, valves, etc.) is estimated automatically every time a cylinder is refilled. This has the advantage that the tare weight does not need to be known beforehand, because it can instead be estimated. Since each cylinder is typically of a fixed volume, due to all cylinders being generally manufactured to the same standards and specifications, it is possible to know how much gas is contained within a full cylinder. As explained above, the tare weight can then be estimated by subtracting the fully loaded gas weight from the total weight of the cylinder.

In some cases it is possible to acquire the tare weight of the cylinder from the distributor. As different cylinders may typically vary in raw tare weight values, even for cylinders which are manufactured to the same specifications, the precise tare weight of the cylinder can be acquired from a distributor, rather than estimating the tare weight, which takes into account any variations between cylinders. The use of an ID tag present on the cylinder can help in this respect because each cylinder can be uniquely identified using its tag meaning that the correct tare weight can be acquired from the distributor.

In general, the algorithms take as part of their input the weight data from the weight sensor and the time the measurement was taken. As the weight data is monitored over an extended time period, it is possible to calculate how the weight of the cylinder changes with time. That is, the derivative of the weight data can be calculated, using the processing module 24 or central proceeding unit, to estimate a change in weight with time. This can be thought of as a velocity vector. Similarly, the derivative of the change in weight over time can also be calculated, using to processing module 24, to estimate the rate of change of weight over time. This can be thought of as an acceleration vector.

Depletion can be thought of as a change in the weight of the cylinder over time, and so is comparable to a velocity vector. The rate of depletion is the rate of change of the weight of the cylinder and so is comparable to an acceleration vector. The weight data, velocity vectors, and acceleration vectors can be used as inputs for the algorithms. These definitions will be used throughout the description when describing the status determining algorithms.

Generally, the algorithms detect how much gas has been used, whether or not the cylinders have been emptied, and whether or not the switch 8 has been activated and changed sides. The remote processing unit 22, which is remote from the cylinder installation 2, therefore monitors the consumer's usage so that it can determine the difference between normal and abnormal usage. Abnormal usage can be used to predict events such as gas leaks, theft, faults in the sensor 10, or user errors, as will be explained in more detail later. When abnormal usage is detected, the processing module 24 sends a wireless signal to the local sensor 10 at the cylinder installation 2 and an alarm 50 in the sensor 10 is triggered. The alarm may be represented by an audio device that could act as an alarm and present a warning of error. Alternatively an alarm may be triggered and sent to a remote warning system.

The results of the algorithms are then reported to the consumer and the supplier so that they know how much gas has been used in a particular time period, for example during each day, and if replacement cylinders 4 need to be ordered.

In general the user can track their own usage and benchmark against other users. They can see when they have higher usage than normal. This also makes the end user sure they are not a victim of fraud or wrong cylinder swapping.

In particular, once the amount of gas remaining in the cylinder 4 has been calculated, the processing module 24 sends the result of the calculation to the user interface 30, which is part of a computing device. This can either be a mobile computing device or a desktop computer in a computer system. The user interface 30 can be a consumer app and/or a supplier/distributor app. That is, both the consumer and the supplier may each have their own user interfaces 30 which can receive the results from the processing module 24. The supplier is therefore automatically informed about how much gas is left in the cylinders 4 in the installation 2 on the local consumer site and can order new cylinders 4 before the consumer runs out of gas. Advantageously, the consumer does not have to manually order the refiling or exchanging of the cylinders 4. In addition, the LPG supplier can better plan their delivery routes and reduce logistics costs. Automatically informing the consumer about how much gas they have left on site allows the consumer to plan their gas usage more effectively and take into account any unexpected peaks in usages, for example during popular business times.

The problem of determining the optimal time when a refill should be undertaken in a cylinder installation 2 (with one local sensor) can be decomposed into two sub-problems. These sub-problems are detecting when a cylinder 4 has started depleting and detecting when a cylinder is empty. The algorithms used to detect these two main events will now be described. From accurately identifying these two events, the point in the cycle of the set of cylinders can be determined.

Starting from an installation 2 comprising full cylinders 4 of gas, the first event in the typical gas cycle is depletion. The start of a depletion event occurs when a cylinder 4 starts to yield gas for the consumer to use either the first time the cylinder 4 is used or after a pause in usage. The most important depletion events to be able to detect are the depletion events that occur after the cylinders 4 have been refilled because this indicates that a switch between two cylinders 4 has taken place.

There are three main techniques which are used to detect depletion events. These techniques are applied sequentially in order to provide a more accurate detection of the depletion event.

The first technique is a simple check as to whether or not the total amount of gas remaining in the cylinder 4 is significantly lower than the maximum weight of gas that the cylinder 4 can hold. In this context, significant is defined as a difference that is large enough to eliminate the possibility of false positives from noisy data. The first check is therefore a simple comparison to see whether the total amount of gas is lower than a threshold value. If the total amount of gas remaining is significantly lower than the maximum weight of the cylinder then it is assumed that the cylinder has started depleting. At this point there is also a check to determine whether a minimum amount of gas has depleted before any other algorithms are allowed to proceed. This ensures that the algorithms are not performing unnecessary computations or performing computations on incorrect data. This technique is a variant of an inverse clamping mechanism. That is, the event is instantly rejected if the value is below a minimum threshold value and instantly accepted if the value is above a maximum threshold. These thresholds are initially set at a starting value and then determined using machine learning algorithms, so that the accuracy of the algorithms is improved over time.

In more detail, before the main depletion detection algorithms are run, a number of initial checks are performed. Firstly, it is checked whether the current weight of the gas cylinder 4 is above a maximum threshold value. This maximum threshold value is used to indicate that the cylinder 4 is full and so is chosen to approximately represent the weight of a full cylinder 4. This threshold value can be set to any reasonable value that would indicate the cylinder 4 is full and can be reconfigured and adjusted at any time. As an example, the maximum threshold could be set to 97% of the estimated total weight. If the current weight is above this maximum threshold, it is determined that the cylinder 4 is substantially full and that depletion has not yet begun. The rest of the depletion detection algorithm is then aborted to save computing resources and reduce unnecessary calculations.

If the current weight of the cylinder 4 is less than this maximum threshold, it is then checked whether the current weight is below an upper threshold. This upper threshold value indicates that current weight of the cylinder 4 is slightly less than the weight of the cylinder 4 when full suggesting depletion has started. This threshold value can be set to any reasonable value and can be reconfigured and adjusted at any time. As an example, this threshold value could be set to 90% of the estimated total weight. If the current weight is below this threshold, it is determined that depletion has started.

Detecting depletion in the weight range between the upper minimum threshold (for example 90%) and the maximum threshold (for example 97%) can be done using regression, for example linear regression, which attempts to fit a linear curve to the weight data falling within this range. The fit represents the rate of change of the weight data i.e. the acceleration. If the resulting fit has a slope within an interval of acceptance and a R² value above a threshold value, for example 95%, it is determined that the data is declining steadily close to the estimated rate of depletion and so it can be assumed that depletion has started. The interval of acceptance and R² threshold value are predetermined and can be reconfigured at any time.

In an example, the expected value used is 0.03, i.e. 30 grams per minute. The interval of acceptance is 0.03±0.015. The system may also work using machine learning, so that individual restaurants expected depletion rates can be used in place of the static value of 0.03.

If the linear fit does not produce definite results which clearly indicate depletion, the algorithm then tries to find an acceleration outlier within the data. If one or more outliers are found, the algorithm selects the first outlier and then splits the data into two sets. One of the data sets contains this first outlier and the other data set does not contain any outliers. The latter set, i.e. the data set without the outlier, is then selected and the same procedure described above, using regression, is then applied to this data set.

A second example technique used to detect depletion has begun also uses regression, for example linear regression. The data is divided into slices, each slice representing a fixed, predetermined time period. A linear curve is fit to the most recent data slice. The time period used for the data slice is any reasonable time period but should not be so large such that changes in depletion rate would not be able to be detected and go unnoticed. If the linear curve can be fitted with an acceptable R² value, which is a measure of how close the data points are to the fitted regression line, and additionally the slope of the curve is close to the typical depletion rate of the system, this indicates that the cylinder 4 in the system has started depleting. The acceptable value may be set a useful value such as 95%. Further the parameter may be determined by doing a parameter search akin to Hyperparameter optimization.

A third example technique looks at larger points of negative accelerations, with associated negative velocities, in the curve. If a larger negative acceleration is found, and the slope of the fitted curve after the point where the negative acceleration occurs is also negative, this further indicates that the system has started depleting. The data points after the negative acceleration point is then fitted against a linear curve as before and accepted under the same conditions as before.

A number of different parameters are used to determine whether a depletion event has occurred. These parameters include the recent weight of the cylinder 4 (typically, the data points will span a 6-12 hour time period), the tare weight and maximum weight of the cylinder 4, the value of a typical depletion rate, and the minimum and maximum values used in the inverse clamping mechanism mentioned previously.

Machine learning algorithms, such as neural networks, can be used to determine the start of a depletion event. An example of a machine learning algorithm that can be used to detect whether depletion has started is a regular, dense neural network that has been trained on real test data. The neural network ingests smoothed and filtered data and the parameters of the cylinder and commercial property, if relevant, and then uses these to determine whether or not a depletion event has occurred. In particular, the neural network takes as its input vectors of derivatives, i.e. velocities, and accelerations. This algorithm is able to detect when one side of the cylinder installation 2 is empty. When a cylinder 4 starts depleting, it follows that the other side has finished depleting and is now empty and a switch has just recently been made.

In the present description, we refer to neural networks as an example machine learning algorithm to implement the determination techniques. Where this term is used, it can be considered that any suitable machine learning technique may be used. For example, artificial neural networks may be preferable but similarly a support vector machine, recurrent neural network, or convolutional neural network may be used including for example Tensorflow libraries. Additionally, reinforcement algorithms may be utilised to improve determination.

In summary, a neural network is trained using parameters such as the ambient temperature of the cylinder at the time test weight data was recorded with the exact volume of gas in the cylinder. The test data may for example use certified control weights approved by regulatory bodies. Once trained and the hidden layer has its weights set, in use the input layer may include the parameters such as the tare weight and acceleration of weight data. Each parameter is therefore weighted by the trained neural network and summed to derive a conclusion as to the likely event. The output layer is the decision of the event categorisation as a result of the weighted parameters. Advantageously, the neural network can be trained on data from more than one user, improving the accuracy of the neural network over time.

In a typical lifetime cycle of one cylinder 4, the depletion of gas will likely start and stop several times as the consumer does not generally need a constant supply of gas. For example, the consumer will use the gas during commercial business hours and will not use the gas during the night. There are therefore several start and stop events which take place during the complete cycle of the cylinder 4.

In order to detect a temporary pause in depletion the same algorithm that is used to detect the main initial depletion event is used, except that the initial conditions are not used. In addition, the algorithm reverses the requirements for the slope, requiring in this case steady non-declining data, instead of steady declining data.

In order to determine when the cylinder has temporarily started depleting again after a pause, the same algorithm that detects when the initial, beginning depletion event occurs is used however, in this case, the initial conditions are not used. This is because the cylinder is resuming depletion after a pause has taken place and so the initial conditions will vary each time the cylinder restarts depleting.

It is useful to be able to predict when the cylinder 4 is about to become empty, or when it will no longer yield gas, before this state is actually reached so that replacement cylinders 4 can be ordered before the consumer actually needs them. An emptiness predication algorithm is therefore used to predict when this point will occur. In this context, “empty” refers to the ability of the cylinder 4 to yield gas and not the amount of fluid in the cylinder 4, in either liquid or gas form.

Thus an empty cylinder 4 is a cylinder 4 that no longer has the ability to yield gas and an emptiness prediction algorithm predict when this state will be reached. Factors that affect the amount of gas a cylinder can yield include gas volume, temperature, and pressure due to a state change of the LPG in the cylinder.

The emptiness prediction algorithm retrieves the current rate of depletion up until a particular point in time and then extrapolates the rate of depletion to provide an indication of when the cylinder 4 will become empty. Depletion rate estimates are calculated at various different time intervals (for example over the last 24 hours, over the last week, and over the life time of the cylinder) which can be combined to provide a more accurate result. An accurate prediction of the end point will allow the gas suppliers and distributors to plan deliveries in advance on a much larger scale.

The emptiness prediction algorithm is also a machine learning algorithm which uses a regular, dense neural network to perform the extrapolation and predictions. The inputs to the neural network include parameters such as “x % gas remaining” or “n days since depletion started”. The output of the algorithm is a number estimating how much longer the cylinder 4 can be used for, based on current usage rates. This result may be presented, for example, as a number of remaining days or hours.

Data for specific locations or specific times of the year can also be input into the emptiness prediction algorithm. For example, the neural network may also use parameters such as “the average depletion rate on a Monday” and “average depletion rate during Easter” for a particular restaurant. These factors are combined with parameters common to all cylinders 4, such as “percentage of gas remaining” to estimate when the amount of usable gas in the cylinder 4 will be reached. Thus, an advantage of using a neural network over current systems is that the neural network learns and is trained on data from all users that are part of the system, improving the accuracy and performance of the neural network over time.

The final event in the lifetime of a cylinder 4 is when the cylinder 4 becomes empty and the switch 8 in the cylinder installation 2 switches cylinders 4 on the other side of the installation 2. In order to determine when a switch between cylinders 4 should be made, it first needs to be determined when a cylinder 4 has been emptied. As mentioned, this can be difficult because a cylinder 4 can be physically non-empty but still not yield any gas to the pipeline 6. Thus, instead of detecting an absolute value of “emptiness”, the status determination system instead detects when the cylinder 4 has ceased to release any more gas i.e. when the cylinder 4 has reached a steady, non-depleting state.

Furthermore, although a cylinder 4 may have stopped yielding gas, this does not necessarily correspond to an “empty” condition. It could instead indicate a temporary pause in gas usage at the consumer end and so the algorithms need to be able to identify and distinguish between these two situations.

Various factors can affect whether or not a cylinder 4 will completely empty during one complete cycle or if instead the cylinder 4 will still retain some residual fluid. One factor of particular importance is the temperature which is proportional to the pressure inside the cylinder 4. In cold temperatures the cylinders 4 will have some residual fluid remaining inside at the end of their cycle and in warmer temperatures, each cylinder 4 will be substantially empty at the end of each cycle.

Other external factors that affect the amount of usable gas in each cylinder 4 include the air pressure. Thus, in order to accurately predict the emptiness of cylinders 4, local weather data can be combined with the weight and temperature data to provide a more accurate estimation of the amount of gas present in the cylinder 4. The weather data can be stored on the cloud server 26 and retrieved by the remote processing unit 22, via wireless data communication systems. The retrieved air pressure is therefore an additional weighted parameter, in conjunction with the temperature and weight parameters, used by the status determining algorithms

As can be seen, a number of parameters are used to determine when the cylinder 4 has reached an empty state rather than a temporary pause. As well as the above mentioned parameters, additional parameters include the current percentage of gas in the cylinder 4, current weight, and current cylinder tare weight. The status of the cylinder 4 at a time interval immediately before any current measurements are taken by the sensor 10 can be used to predict the current status of the cylinder 4. For example, the system 22 can take into account whether the cylinder 4 has been previously depleting, in which case it may now be empty, or whether it was temporarily paused, in which case it is likely still paused.

If the cylinder 4 is located at, and used on, commercial property, the opening hours of the property can be taken into account to help determine whether the cylinder 4 is empty or whether there is a temporary pause in usage.

Other information which may also be taken into amount are the time since the last known time the cylinder 4 was depleting and aggregated information about the typical remaining weight of the cylinder 4 when it stops yielding.

The algorithm used to detect that a cylinder 4 is empty works by directly inspecting the data and setting a threshold at which the cylinder 4 is considered empty, for example 5% of the total weight of the cylinder 4. The threshold can be set at any reasonable value, and is reconfigurable by the supplier. In conjunction with this algorithm, the data is also inspected to make sure that depletion has stopped rather than is temporarily paused.

When the emptiness algorithm is combined with contextual information, as described above, the emptiness algorithm becomes a machine learning algorithm. The primary contextual information is the ambient temperature which is measured using the temperature sensor 44. As explained, if the temperature of the cylinder 4 is sufficiently low the cylinder 4 can stop yielding gas before it is physically empty. This is because a lower temperature corresponds to a lower pressure and so the gas cannot escape the gas cylinder. Correlating this information with local weather reports provides similar contextual information from another source. In an example, the local weather report is another source of contextual information regarding the temperature. This could make inferences using temperature more accurate (two is better than one, and so on). Weather data may also relate to the prediction of potential temperature drop and drop of pressure. The machine learning emptiness algorithm is a regular, dense, neural network trained on real test data. The network takes as its input a vector of the percentage values of the amount of gas in the cylinder 4 along with the contextual information from, for example, the temperature sensor 44.

Once it has been determined that the cylinders 4 on one side of the installation 2 are empty, a switch is made and the other cylinders 4 start yielding gas. The whole process then begins again, the sensors 20, 44 monitoring the weight and temperature of the cylinders 4 and the processing module 24 calculating the amount of gas in the cylinder 4 using the machines learning algorithms.

At the same time the switch is made, the supplier is notified of the switch and the empty cylinders 4 can be refilled. It is important to be able to detect once the cylinders 4 have been refilled so that the switch 8 does not switch to an empty set of cylinders 4. In this case, the consumer or supplier can be alerted, via the user interface 30, that there is a problem with the installation 2.

In order to detect that a cylinder 4 has been refilled, after initially filtering the weight data, an algorithm is run on the weight data which attempts to find a derivative which is both positive and of at least a target minimum value. The minimum value can be set to any reasonable value, for example 10 kg. The algorithm can be a regular, dense, neural network that has been trained on real test data. The neural network takes as its input a single vector of derivatives and outputs a Boolean flag. The determination system 18 automatically deduces the new total weight of the gas cylinder 4 which is being monitored. Given that the total amount of initial gas in each cylinder 4 is fixed, and therefore known, it is possible to deduce the tare weight of the cylinder 4. This information is then used to accurately calculate the remaining percentages of gas in the cylinder 4 as the cylinder 4 is being used. When a cylinder 4 has been refilled the system 18 will mark the customer as no longer needing new gas. This detection algorithm therefore forms part of a subsystem which informs the gas distributors which customers need gas.

As well as monitoring normal usage and operation of the gas cylinders 4, it is important to be able to determine when the gas cylinders 4 are not behaving as expected or when consumer usage appears abnormal. Unusual behaviour of the gas cylinders 4 may indicate that the gas cylinder 4 is leaking which could be dangerous. Abnormal usage by the consumer could indicate that the cylinder 4 has been stolen or is being used by unauthorised persons. Other, non-standard events which are important to be able to identify include user errors, installation errors, and sensor failures. These events can all be indicated to the consumer and supplier through the user interface 30 and the local alarm 50 at the cylinder installation 2.

Algorithms for detecting abnormal usage and abnormal operation of the gas cylinders will now be described.

Detecting whether or not a leak has occurred is important so that potentially hazardous situations can be avoided. In order to detect whether or not the cylinder 4 is leaking a leak detection algorithm first detects when a cylinder 4 has stopped depleting “for the night”. That is to say at the end of a predetermined time period, for example at the end of each day, the consumer will no longer be using the gas cylinder 4 and so there will be a temporary pause in depletion. The leak detection algorithm then monitors the status of the cylinder 4 and determines when depletion has begun again, indicating the start of the next time period, for example the start of the next day. A linear curve is then fit to the sensor data between the depletion stopping and starting up again using regression, typically linear regression, and the average rate of depletion between the two time periods, for example over the night, can be calculated by analysing the slope of the data. If the slope is within a given threshold and has a very high R² value, the data is flagged as leaking. In particular, if the slope is above a lower bound which indicates a period of inactivity, for example a lower bound substantially close to zero, but the slope is also below an upper bound which indicates usage, any slope falling within this range will indicate that there is a leak. This is because a substantially non-zero slope indicates depletion whilst a substantially horizontal slope indicates there is no depletion. A leak occurs when small levels of gas escape from the cylinder 4 but not at the same levels as would be used by a consumer 4. The upper and lower bounds are therefore chosen to detect this small change in gas levels.

Thus in general in order to detect a leak, periods of inactivity are analysed to see whether or not there is some small level of depletion happening during the period of inactivity. In this sense, the determination system can be thought of as self-aware because it is able to itself detect if something is not right, this refers to the sensor's capability to itself detect suspicious behaviour of the system. It is also possible for gas distributors to keep a closer eye on the behaviour of the gas cylinders 4 and their usage, allowing them to react more precisely to customer demands.

The performance of the determination system 18 relies on the sensor 10 at the cylinder installation 2 measuring the weight and temperature of the cylinders 4 and sending these signals to the remote processing unit 22. If the sensor 10 fails then it will stop sending real time data to the remote processing unit 22 and the current status of the cylinders 4 cannot be determined. This is problematic as the supplier relies on accurate estimations of the amount of gas left in the cylinders 4 so that they can predict when the consumer will run out of gas. Abnormal usage will also not be able to be detected if the sensor 10 is not working properly.

If the sensor 10 fails then historical data, which has been collected over time and stored on the cloud-based server 26 while the sensor 10 was working, is instead used to predict when it is time to change or refill the cylinders 4. Using historical data reduces the impact of a non-functioning sensor 10 and ensures that the consumer will not run out of gas while the sensor 10 is down.

The historical data may refer to some or all of the data emitted by the sensor available. Some of it might be raw data, some of it might be aggregations. This historical data tells the system about the expected amount of time between refills, between a refill and until depletion, the expected depletion rate, and any other types of feature/event detected.

When a sensor fails, the system can—using the latest known data of a sensor—thus predict the expected amount of time until a refill has occurred. When a refill then has occurred (which on failure will be set at the expected time, or edited manually by the users of the system), the system may use the historical median difference (the exact technique might vary in the future) between refills as the next expected refill.

Sensor failure can be detected using various techniques. For example, if the remote processing unit 22 stops receiving sensor data over a predetermined time interval, it will determine that the sensor has failed. In addition, or as an alternative, the sensor may send an error signal to the remote processing unit 22 which, in turn, may send an indication of the sensor failure to the user interface 30 to notify the consumer and/or distributor.

The system may use two primary techniques to detect a sensor failure. First, if the sensor stops sending data (each sensor has a defined transmission interval, typically around 30 minutes. If a sensor doesn't send data within 2× this interval, the sensors state is defined as _not sending data). Second, the sensor itself sends some error signal. The sensor can send a number of different signals indicating the specific error that might have occurred.

When the sensor 10 fails an alarm is triggered. This alarm alerts the gas supplier that the sensor 10 is not functioning properly and needs to be replaced the next time the gas supplier is at the customer site. The remote processing unit 22 will then use historical data, which includes a safety margin, to predict when it is time to do the next gas refill. The supplier then replaces the sensor 10 when doing the next refill and the system 18 resumes as normal for that particular consumer. The safety margin ensures that the cylinder 4 is refilled or replaced slightly too soon rather than too late so that the consumer does not have to go through a period in which they do not have a supply of gas.

Other errors which are important to identify include user errors, user interference, and data pollution due to environmental reasons. Examples include: Earthquakes (vibrations); Trains and trams (vibrations); General traffic (vibrations); Very high temperatures; Very low temperatures; and, Other objects periodically or otherwise touching the sensor. An error detection algorithm looks at the number of noisy data points that would be removed during a noise removal process. If the number of noisy points is consistently high, compared to a predetermined acceptable number of noisy data points, then this indicates that either the sensor is having problems or there is an external factor which is polluting the data.

The different types of disturbances can be categorised using machine learning and classifying training data used by the neural network. The machine learning error detection algorithm uses standard case-based reasoning with Bayesian interference to distinguish between user errors or interference, sensor failures, and environmental factors affecting the data.

In order that the status detection and depleting algorithms perform optimally, it is important to be able to remove and smooth noise. In general, this process involves removing outliers and then smoothing the remaining data points.

It is important to distinguish between noise removal and noise filtering. Algorithms that perform noise removal are designed to remove points which are considered too noisy to be used in further calculations. These data points are typically one-off outliers or similar. Noise removal algorithms do not alter any point that is not considered an outlier and the overall shape of the data remains the same. On the other hand, noise filtering algorithms smooth the data. These algorithms filter, or smooth, unwanted components or features of a signal. As a result, the overall shape of the data will likely be different to the original shape after noise filtering algorithms have been applied. In general, the removal algorithms are applied first and then the data is filtered.

Different events require different smoothing and filtering techniques. For example Savitzky-Golay or SOS filtering greatly affects discontinuities in the graph and so these filtering techniques are not suitable for detecting when a refill event has occurred, as this will be indicated by discontinuity in the weight data graph. Since it is the discontinuity feature which is of interest when detecting this particular event, filtering techniques which heavily affect discontinuities cannot be used.

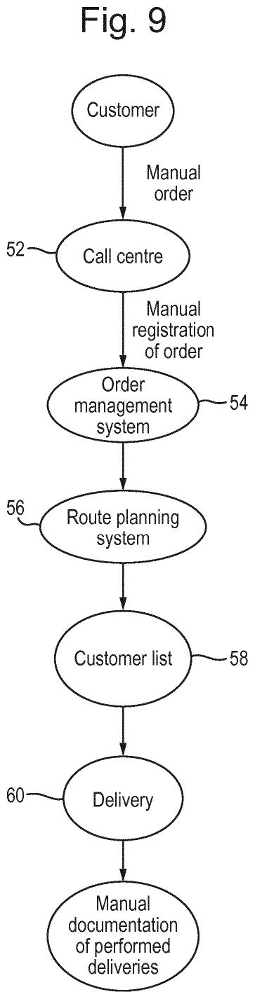

A typical workflow for a current gas supplier delivering gas cylinders to a consumer is illustrated in FIG. 9. Typically, the customer manually places an order for a gas cylinder 4 through a central call centre 52. This order then gets manually registered in an order management system 54 and the customer's location details will be entered into a route planning system 56. Based on a list 58 of customers that have placed orders, the supplier will plan a route accordingly and deliver 60 the gas cylinders 4. As each cylinder 4 is delivered to a customer the supplier will make a manual record 62 of a successful delivery which can then be entered into the main management system 54 so that there is a log of that particular delivery session.

As is evident, current systems need the driver and administration to manually register orders into the order management system 54 and record when the deliveries have been completed.

The proposed determination system 18 described here reduces the need for manually keeping track of when cylinders 4 need replacing, verifying that the delivery has been made, and updating consumer records because the determination system 18 can accurately estimate consumer usage and predict when the gas cylinder will run out. Furthermore, the determination system 18 can flag up abnormal occurrences and alert both the consumer and supplier to potentially hazardous situations. Thus the chance of human error can be reduced.

A side effect of being able to accurately determine the amount of gas in the cylinder installation 2 and predict when the cylinders 4 will become empty is that the logistics system used by the supplier can be optimized. The logistics system optimization will make use of the prediction data, local sensor data, global condition data (through the use of cloud based sensors and/or remote sensors), and big data stored in the cloud-based server 26.

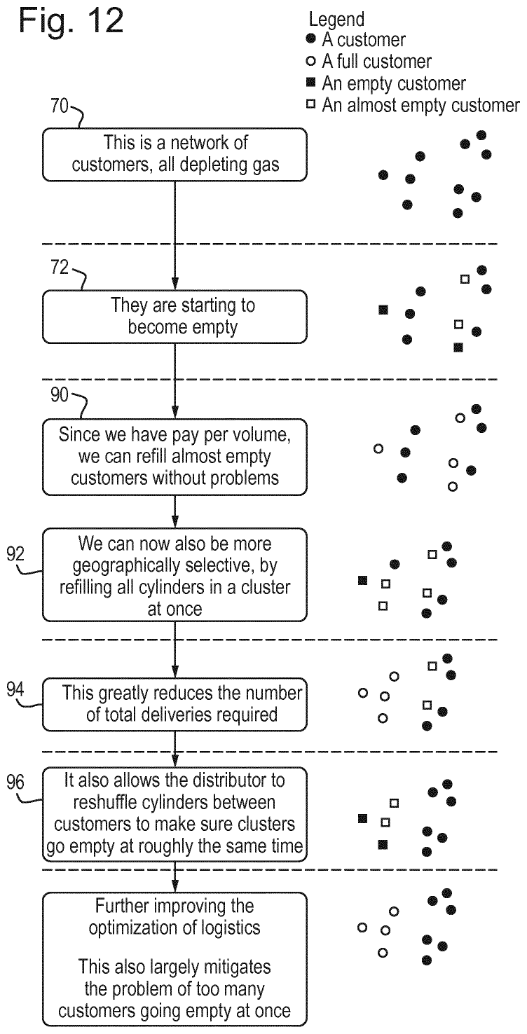

An optimized logistics workflow is illustrated in FIG. 12. As with current workflows, there is a network 70 of customers who are all actively using gas cylinders, for either private or commercial use. Again, over time these cylinders start to become empty 72.

However, unlike with current workflows, the new workflow uses the prediction system 18 to monitor how much gas the consumers have left in their cylinders, as well as being able to alert a consumer when their cylinders are nearly empty rather than discovering they are empty when it is too late. The supplier can therefore plan a delivery route in advance of consumer actually running out of gas 90 so that a consumer does not have to go through a period with no gas. Since the supplier has information about how much gas is left in all the cylinders in the network, the supplier can be geographically selective 92 with his refills by only refilling cylinders within a particular region. This may include refilling consumers that are nearly empty as well as topping up consumers which would become empty in the near future. The supplier therefore needs to make fewer delivery trips 94, as well as being able to carry only the amount of gas required for a particular area. Another advantage of using the prediction system 18 to optimize the delivery workflow is that a supplier can chose to redistribute 86 cylinders between consumers, depending on the level of gas usage for each consumer, to make sure that all the cylinders in one particular area are emptied at approximately the same time. This further improves the efficiency of route planning between consumers and reduces the number of spare cylinders that need to be carried by the supplier.

The logistics system can therefore be optimized in terms of routing planning (in that similar locations can be grouped together and the same location is not visited more than once per trip), collection and delivery times to better suit the consumer, as well as reduced delivery counts.

Additionally, with a more optimized system, the number of cylinders that a consumer needs to store on site can be reduced, in some cases halved, as a result of better route planning, and delivery times more efficiently coinciding with times when the cylinders are about to become empty. This may also allow the number of deliveries (i.e. the number of trips that need to be made by the supplier to delivery gas to the consumers) to be reduced.

Additionally, the determination system 18 applied to a current cylinder logistics system would provide the possibility of selling gas to the consumer based on the amount of gas actually used by the consumer, rather than per unit cylinder. In this case, the consumer only pays for the gas they actually use rather than paying for whole cylinders, which may be replaced or refilled before they are completely empty. As explained above, this is made possible through the use of certified control weights.

As well as the cost saving advantages to the consumer, this system would reduce the number of cylinders 4 that need to be stored on site. If fewer cylinders 4 are stored at different consumer site locations, the security of the overall LPG provider system is improved because it is easier to store and keep track of fewer cylinders 4. In addition, the impact of an error occurring is also reduced if the total number of cylinders 4 in the system in reduced. Furthermore, the size of each cylinder 4 can be reduced because the determination system 18 is able to more accurately determine how much gas in present in each cylinder 4 and so a smaller safety margin, or safety buffer, of gas in the cylinder 4 is needed before new cylinders 4 are ordered.

As before, a local weight sensor 20 sends signals to a remote processing module 24 which uses the signals to estimate the amount of gas present in the cylinders 4. Usage patterns that are linked to specific dates along with weather data are used to estimate when consumer usage is likely to increase beyond normal usage. For example, during cold weather more gas will be used in central heating systems and during holidays certain commercial properties such as restaurants will be busier and so will use more gas for catering.

It would therefore be useful to be able to determine whether or not the gas cylinders 4 received by the consumers are certified and regulated rather than being supplied by fraudulent distributors. Additionally, since gas cylinders 4 are a valuable commodity for the consumers it would be useful to be able to track and monitor the gas cylinders 4 that have been delivered to each consumer to prevent them from becoming targets for thieves. Furthermore, if the cylinders 4 do get stolen, it would be beneficial to be able to track the cylinder 4 so that it can be found and returned to either the consumer or the gas distributor.

The determination system 18 can therefore include a tracking system for tracking and identifying each gas cylinder 4 that is part of the system. In order to be able to track and identify each cylinder 4 in the overall system, each cylinder 4 may be provided with an ID tag. This could be an RFID tag or a QR code. As well as being able to track the cylinder 4, the ID tag secures the delivery of the cylinder 4 when it is scanned as both the supplier and the consumer will know whether the delivery of the cylinder 4 has been successful or if something may have happened to the cylinder, such as theft, on route. As mentioned previously, the ID tag can also be used to uniquely associated a certified control weight with a particular cylinder. This allows a more accurate payment method to be implemented which is based on the value of gas used by each consumer rather than the number of cylinder's delivered to each consumer, as has been explained previously.

The sensor 10 may include a tracking system reader 64. This may be, for example, an RFID reader. Advantageously, an RFID reader can reduce the likelihood of human errors which may occur when data from large numbers of cylinders needs to be read and recorded. The tracking system reader 64 is used to read the ID tags on the cylinders 4 and send signals wirelessly to the remote processing unit 22. The signals received at the remote processing unit 22 can then be sent to the user interface 30 which notifies the supplier exactly which cylinders 4 have been distributed to and used by which consumers. The supplier and consumer user interfaces 30 can be in wireless data communication with each other so that information about the cylinder 4, (such as estimated delivery time, cost, current usage, new orders) can be shared between the supplier/distributer and the consumer.

To verify the safety and security of the determination system 18, the sensor 10 and algorithms in the system 18 can be calibrated using a certified control weight. The certified control weight can be present at a central site or in a transport vehicle. Thus, an accurate certified control weight is used to verify the amount of gas used in the cylinder 4. The certified control weight can also be used to detect errors in the system 18, and to secure and open up payment to the consumer based on gas usage rather than based on number of cylinders 4 delivered. For example, if the certified control weight indicated that a particular cylinder had been under-filled, compared to an expected “full” cylinder weight, the consumer would receive a cylinder with less gas in and so should not be charged the same price as the price of a “full” cylinder. Similarly, if the certified control weight indicated that a particular cylinder had been overfilled compared to an expected “full” cylinder, the consumer can be charged for this extra gas that they have received, rather than the gas supplier losing out on money.

In particular, by accurately determining and verifying the volume of gas in each cylinder 4 before and after the gas cylinder 4 has been refilled, it is possible for the gas supplier to charge the consumer for the volume or gas that was actually used, rather than charging a fixed price per gas cylinder. This can be implemented in two ways.

One possibility is to give the consumer a discount on each cylinder 4 which is proportional to the amount of gas that would typically be left in the cylinder 4 when the cylinders 4 are due to be refilled or exchanged. For example, the consumer may receive a 20% discount on each cylinder 4 and when the amount of gas in each cylinder 4 is below 20%, the gas distributor replaces the cylinder 4 with a new full cylinder 4. The customer therefore only pays for the gas that they actually use.

An alternative solution is for the gas distributor to replace all the cylinders 4 in a geographical region which contain an amount of gas below a certain threshold.

For example, the gas distributor may replace all cylinders 4 in a particular region which contain less than 40% gas. When the cylinders 4 are returned to a filling station at the supplier end, the economic compensation from the consumer is calculated based on how much gas is left in the cylinder 4. This calculation is done using the certified control weight. Each cylinder 4 can be tracked using, for example, RFID tags so that each cylinder 4 is associated with a particular customer.

The control weight measures the weight of each cylinder 4 at the cylinder installation 2 when the cylinder 4 is refilled, or at a separate location if the cylinder 4 is refilled at a separate filling station, and this information is then sent to the remote processing unit 22. At the same time, the tracking ID tag on the cylinder 4 is scanned by the tracking system reader 64 and the scanned information is also sent to the remote processing unit 22. The combination of using a certified control weight and a tracking system ensures that each cylinder 4 can be correctly identified and accurately weighed so that the customer can be charged the correct amount based on their actual gas usage.

Charging customers per volume of gas used rather than per cylinder will reduce the cost of logistics for the gas distributor. This is because the distributor can change their deliveries from being order orientated to being geographically orientated. The gas distributor can now focus on all the cylinders 4 in a particular geographical region. For gas installations, the supplier can also change all the cylinders 4 in a particular region in one delivery. This dramatically reduces the number of deliveries needed at a specific location.

As is clear, the main users of the status determination system 18 are the gas distributors and suppliers who use the system 18 to monitor how much gas their customers have left before the cylinders 4 need replacing. The whole process can be automated which reduces the risk of human error in the system.

Accurate usage estimation by the processing module 24, based on signals from the sensor 10, provides a number of advantages. Firstly, the number of user errors is dramatically decreased. Previously, false alarms could be created because of the end-user intervening with the sensor 10 during installation. For example the user may not place the cylinder 4 directly on top of the cylinder which may lead to false weight measurements of the cylinder 4. The presently described system 18, on the other hand, avoids this problem through automation which provides consumers and suppliers with an accurate estimation of the amount of gas left in each cylinder as a percentage of the total amount of gas. As a result, errors can be detected either manually by the gas distributor or automatically through the use of algorithms. Being able to detect user errors avoids the possibility of unnecessary deliveries and so keeps logistics costs down.

Secondly, abnormal patterns in gas consumption can more easily be detected which may help identify and reduce gas leakages and other potentially hazardous situations.

False alarms due to low temperatures are also avoided through accurate calculation of the amount of gas left in cylinder.

In summary, a system is provided which allows users (including gas suppliers and consumers) to monitor and infer the status of an entire cylinder installation by monitoring only one cylinder within the entire installation. There is no longer the need to monitor an entire array of cylinders within the installation, which has cost savings as well as efficiency improvements. The system provided is able to estimate patterns for LPG usage based on “big data”. This can give an optimized logistics system, by knowing the usage pattern of a consumer. For example, data shows low usage on Saturday and higher usage on Fridays etc. which can allow the system to accurately predict usage and future available gas yield.

Additionally, a more accurate predication system of when the consumer will run out of gas is provided which has benefits for the supplier, distributor, and consumer of the prediction system.

Finally, the system may also provide energy saving advantages. Since the status and typical depletion rate of the cylinders being monitored is known, the sensors can transmit data less often within certain time periods (straight after refill, for instance), when it is known that the time until the next event is likely to be long. This therefore saves energy of the sensor.

1. A system for determining a status of a gas cylinder, the system comprising:
a plurality of cylinders;
a load sensor configured to detect a weight of the plurality of cylinders at predetermined time intervals;
a temperature sensor configured to detect a temperature local to the plurality of cylinders at the predetermined time intervals; and
a processing unit configured to:
receive weight signals and temperature signals from the load sensor and temperature sensor respectively;
determine, based on the received weight and temperature signals, the status of the plurality of gas cylinders; and
provide an indication of the status of the plurality of gas cylinders to a user,
wherein the load sensor is associated with only one of the plurality of gas cylinders.

2. The system according to claim 1, further comprising a transceiver configured to receive signals from the load sensor and the temperature sensor, the signals corresponding to weight data and temperature data respectively, and send the weight data and temperature data to the processing unit.

3. The system according to claim 1, wherein the processing unit is configured to retrieve a tare weight, calculate a difference between the tare weight and the received weight data to determine a weight difference, the processing unit subsequently configured to:
compare the weight difference with a threshold value; and
modify the comparison using the received temperature data.

4. The system according to claim 3, wherein the processing unit is configured to estimate a percentage of gas in the cylinder from the modified comparison.

5. The system according to claim 4, wherein the processing unit is further configured to apply a regression model to a change in the estimated percentage of gas in the cylinder over a plurality of time intervals, the output of the regression model indicating the status of the cylinder.

6. The system according to claim 5, wherein the processing unit is further configured to apply a regression model to a change in the weight data over a plurality of time intervals, the output of the regression model being used to determine the status of the cylinder based on the temperature data.

7. (canceled)

8. The system according to claim 4, wherein the processing unit is configured to estimate when the status of the cylinder is considered to be no longer yielding by comparing a percentage of gas in the cylinder with a minimum threshold value and if the percentage is below the minimum threshold value and remains unchanged for a predetermined time period, provide an indication to the user that the cylinder is no longer yielding gas.

9. The system according to claim 4, wherein the processing unit is configured to estimate when the status of the cylinder is considered depleting by identifying a change in percentage of gas over a predetermined time period, comparing the percentage of gas in the cylinder with a reference value and an upper threshold value and if the percentage is less than both the reference value and the upper threshold value, provide an indication to the user that the cylinder is considered to be depleting.

10. The system according to claim 4, wherein the processing unit is configured to estimate the percentage of gas at a first time period and a second time period and calculate a difference, the processing unit subsequently configured to:
compare the difference with a lower reference value and if the difference is substantially equal to the lower reference value, provide an indication to the user that the cylinder is considered to be in a period of inactivity; and
compare the difference with an upper reference value and if the difference lies between the upper threshold value and the lower threshold value, provide an indication to the user that the cylinder is considered to be leaking.

11. (canceled)

12. The system according to claim 1, wherein the processing unit is configured to retrieve historical data from a cloud-based server and the determination of the status of the cylinder is carried out on the historical data.

13. The system according to claim 1, wherein the processing unit is remote from and in communication with the load sensor and temperature sensor, the load sensor and temperature sensor being local to the gas cylinder.

14.-15. (canceled)

16. The system according to claim 1, wherein the plurality of cylinders is arranged into at least two groups wherein each group comprises at least two cylinders.

17. The system according to claim 16, wherein the gas cylinder with which the load sensor is associated is itself associated with only one of the at least two groups.

18. The system according to claim 1, wherein the processing unit is further configured to retrieve a certified control weight of the gas cylinder and use the certified control weight to calibrate the step of determining the status.

19. The system according to claim 1, wherein the cylinder comprises a machine readable identification tag comprising unique information to identify the cylinder and wherein the processing unit is configured to receive the identification tag applied to the cylinder and associate the unique information with the received weight data and temperature data.

20. The system according to claim 1, wherein the processing unit is further configured to retrieve a plurality of input parameters comprising the weight data and temperature data, apply a weight to each of the input parameters to generate a set of weighted input parameters and sum the weighted input parameters to identify the status of the cylinder.

21. The system according to claim 20, wherein the processing unit comprises a neural network trained on test data, the neural network configured to receive the input parameters, operate on the input parameters, and output a status of the gas cylinder based on the operation performed on the input parameters.

22. The system according to claim 20, wherein the plurality of input parameters further comprises one or more of:
estimated percent of gas in the cylinder at a first time;
weight of the cylinder at the first time;
cylinder tare weight;
opening hours of a property where the cylinder is installed;
a depletion status of the cylinder indicating whether the cylinder is currently depleting or currently paused;
a time since the last known time the cylinder was depleting;
aggregated information about typical weight for the cylinder when it stops yielding gas;
weather conditions, including temperature data; and
signals from at least one additional local sensor selected from the group consisting of: an ultrasound sensor, an external temperature sensor, an infrared temperature sensor, and a flowmeter.

23. The system of claim 22, wherein the depletion status is determined either:
by calculating a rate of change of the received weight data over a time period; or
using a set of weighted input parameters comprising:
a plurality of smoothed and filtered weight data measurements over a time period;
cylinder tare weight;
a maximum weight of the cylinder; and
a typical depletion rate.

24.-32. (canceled)

33. A method of determining a status of a gas cylinder, the method comprising the steps of:
detecting a weight of a plurality of gas cylinders, using a load sensor, at predetermined time intervals;
detecting a temperature local to the plurality of cylinders, using a temperature sensor, at the predetermined time intervals;
receiving, by a processing unit, weight signals and temperature signals from the load sensor and temperature sensor respectively;
determining, by the processing unit, the status of the plurality of gas cylinders based on the received weight and temperature signals; and
indicating to a user the status of the plurality of gas cylinders,
wherein the load sensor is associated with only one of the plurality of cylinders.

34.-63. (canceled)
